(19) United States
(12) Patent Application Publication
(10) Pub. No.: US 2026/0016117 A1
(43) Pub. Date: Jan. 15, 2026

(54) Satellite Antenna Positioner

(71) Applicant: Kinematics, LLC, Phoenix, AZ (US)

(72) Inventors: Adam P. Plesniak, Huntington Beach, CA (US); Brandon LARSON, Lakewood, CA (US); Scott LEACH, Gainesville, GA (US)

(21) Appl. No.: 19/313,489

(22) Filed: Aug. 28, 2025

Related U.S. Application Data
(63) Continuation of application No. PCT/US24/18959, filed on Mar. 7, 2024.
(60) Provisional application No. 63/450,498, filed on Mar. 7, 2023.
(60) Provisional application No. 63/500,140, filed on May 4, 2023.

(51) Int. Cl. F16M 11/18; F16M 11/10; F16M 11/20; H01Q 3/08

(52) U.S. Cl. CPC F16M 11/18; F16M 11/10; F16M 11/2021; H01Q 3/08

(57) ABSTRACT

Systems and methods for positioning a payload are provided including at least one slew drive configured to rotatably secure to a payload, the at least one slew drive including a first worm gear, a second worm gear, and a worm wheel engaged with the first and second worm gears, a first gearmotor configured to rotate the first worm gear, a second gearmotor configured to rotate the second worm gear, and a controller configured to bias at least one of the first gearmotor and the second gearmotor relative to the worm wheel.

### CROSS-REFERENCE

This application is a continuation of International Patent Application No. PCT/US2024/018959 filed Mar. 7, 2024, which claims the benefit of U.S. Provisional Application No. 63/450,498, filed Mar. 7, 2023, and U.S. Provisional Application No. 63/500,140, filed May 4, 2023, each of which is incorporated by reference herein in its entirety.

### BACKGROUND

Satellite antenna positioners direct antennas toward their targets as either the targets move, or the earth rotates relative to the targets. Antennas may require targeting or tracking across the entire horizon of the sky with high precision. Satellite antenna positioners utilize complex motorized drives to rotate an antenna in different directions to account for movement to an orientation and maintaining that orientation. Precision for tracking targets with the satellite antenna has required complex motors and gears with active braking.

### SUMMARY

In some embodiments, a positioning system for repositioning a payload may include at least one slew drive configured to rotatably secure to a payload, the at least one slew drive including a first worm gear, a second worm gear, and a worm wheel engaged with the first and second worm gears, a first gearmotor configured to rotate the first worm gear, a second gearmotor configured to rotate the second worm gear, and a controller configured to bias at least one of the first gearmotor and the second gearmotor relative to the worm wheel.

In some embodiments, a modified control signal may be configured to bias sent to at least one slew drive such that a velocity bias may be generated in at least one of the first gearmotor and the second gearmotor relative to the worm wheel. In some embodiments, at least one of the first and second slew drives may be configured to induce a velocity bias relative to the other slew drive of the first and second slew drives based on the control signal. The biasing may be based at least in part on positioning information.

In some embodiments, a positioning system for repositioning a payload may include a slew drive including at least one worm gear and a worm wheel, the at least one worm configured to engage with the worm wheel, at least one gearmotor configured to drive the at least one worm gear. and a controller in communication with the at least one gearmotor and configured to control the at least one worm gear to rotate the worm wheel. The system may include an additional worm gear configured to engage with the worm wheel. The additional worm gear may include two or more worm gears configured to engage with the worm wheel. The controller may be configured to bias the at least one worm gear relative to the additional worm gear.

The payload may be at least one of a telecommunications payload, a solar collection payload, an antenna, a crane arm, a lift, a positioner arm, a robotic arm, a medical imaging device, or an adjustable bed.

The system may further include at least one sensor configured to measure positioning information of at least one of the antennas and the at least one slew drive. The at least one sensor may include at least one of an encoder and an inertial measurement unit. The at least one sensor may be positioned on the payload and/or a bracket coupled to the payload to directly sense the positioning information. At least one of the of the first and second sensors may include at least one of an encoder and an inertial measurement unit. The at least one sensor may be positioned on one of the first or second slew drive.

In some embodiments, a positioning system for repositioning a payload may include a first slew drive including a first pair of worm gears and a first worm wheel, a second slew drive including a second pair of worm gears and a second worm wheel, at least one gearmotor configured to drive each worm gear of the first and second pair of worm gears, and a controller in communication with each gearmotor, the controller configured to bias at least one of the first pair of worm gears and the second pair of worm gears relative to the worm wheel. The at least one gearmotor may include a motor and a reducer assembly configured to drive each slew drive.

The system may include a first bracket securing the first slew drive to the second slew drive and a second bracket securing the first slew drive to the payload.

A modified control signal may be sent to the at least one gearmotor such that a velocity bias may be generated in the first and second gearmotor. At least one gearmotor may include a velocity bias based on the control signal.

In some embodiments, a method for rotating a payload may include receiving a target position for orienting an antenna mounted to a slew drive assembly including at least one slew drive having a first worm gear, a second worm gear, and a worm wheel engaged with the first and second worm gears, determining an angular rotation configured to actuate the slew drive assembly resulting in orientation to the target position, and applying a control signal to bias the first worm gear relative to the second worm gear, and the worm wheel to achieve the angular rotation. The method may include repeating any of the previous steps for a second slew drive.

The method may include applying a modified control signal to at least one worm gear such that a velocity bias may be generated between the first worm gear and the second worm gear.

The method may include inducing a velocity bias between at least one of the first worm gear and the second worm gear relative to the worm wheel.

The method may include receiving positioning information including at least one of an orientation and/or angle of rotation of at least one of the payload and a portion of the slew drive assembly.

In some embodiments, a method for rotating a payload may include receiving a target position for orienting a payload mounted to a slew drive assembly, the slew drive assembly including a first slew drive including a first pair of worm gears and a first worm wheel, a second slew drive including a second pair of worm gears and a second worm wheel, at least one gearmotor configured to drive each worm gear of the first and second pair of worm gears, and a controller in communication with each gearmotor and configured to bias at least one of the first pair of worm gears and the second pair of worm gears relative to the worm wheel, and applying a control signal to bias at least one gearmotor relative to another gearmotor.

Each of the first pair of worm gears and the second pair of worm gears may include a first worm gear and a second worm gear, and where the first worm gear may be actuated at a first velocity and the second worm gear may be actuated at a second velocity.

The method may include inducing a velocity bias between at least one of the first pair of worm gears and the second pair of worm gears. The velocity bias may include about a 5% greater or less than velocity as of the first worm gear or second worm gear. The method may include determining an angular rotation configured to actuate the slew drive assembly resulting in orientation to the target position.

The method may include applying a modified control signal to at least one slew drive such that a velocity bias may be generated between at least one of the first pair of worm gears and the second pair of worm gears.

The method may include receiving positioning information including at least one of an orientation and/or angle of rotation of at least one of the payload and a portion of the slew drive assembly.

In one aspect, disclosed herein is a slew drive actuation system comprising: a primary housing comprising: an oil bath portion comprising a first cavity and a second cavity concentric to the first cavity; a threaded cavity concentric to the first cavity; and a third cavity perpendicular or substantially perpendicular to the first cavity; a first bearing coupled to the primary housing within the first cavity; a second bearing coupled to the primary housing within the second cavity; a worm gear coupled to the first bearing and the second bearing, where the worm gear comprises worm gear teeth; a worm capture coupled to the primary housing within the threaded cavity; and a hollow shaft coupled to the housing within the third cavity, where the hollow shaft comprises shaft gear teeth that couple with the worm gear teeth, and where rotating the worm gear rotates the hollow shaft.

In some embodiments. the primary housing further comprises a fourth cavity concentric to the third cavity, and where the system further comprises a secondary housing coupled to the primary housing within the fourth cavity. In some embodiments, the primary housing, the secondary housing, or both comprises an oil fill plug. In some embodiments, the primary housing further comprises a stop preventing the hollow shaft from rotating about an angle greater than 360 degrees. In some embodiments, the primary housing further comprises a set screw, where actuating the set screw prevents the rotation of the worm capture about the primary housing. In some embodiments, where the primary housing further comprises a water drain slot. In some embodiments, the primary housing further comprises an oil leveling sight. In some embodiments, at least a portion of the surface of the primary housing may be coated with an anti-corrosion primer. In some embodiments, the first bearing, the second bearing, or both, comprises a tapered roller bearing, a solid lubricant bearing, a dry lubricant bearing, or any combination thereof. In some embodiments, the worm gear comprises a first shoulder contacting the first bearing and a second shoulder contacting the second bearing. In some embodiments, the worm capture comprises an inner seal, an outer seal, or both. In some embodiments, the hollow shaft further comprises a water-vapor breather within an inner surface. In some embodiments, the system further comprises a magnet coupled to the primary housing between the first cavity and the second cavity. In some embodiments, the system further comprises a third bearing coupled between the third cavity of the housing and the hollow shaft. In some embodiments, the third bearing comprises a tapered roller bearing, a solid lubricant bearing, a dry lubricant bearing, or any combination thereof. In some embodiments, the system further comprises an oil in the oil bath portion.

Another aspect provided herein is a platform comprising a payload and the slew drive actuation system herein. In some embodiments, the payload may be a telecommunications payload, a solar collection payload, an antenna, a crane arm, a lift, a positioner arm, a robotic arm, a medical imaging device, an adjustable bed, or any combination thereof.

Another aspect provided herein is a method of assembling a slew drive actuation system, the method comprising: providing the slew drive actuation system herein and coupling the worm capture to the threaded cavity of the primary housing with a pre-load torque of about 2 Nm to about 20 Nm. In some embodiments, the method further comprises inserting the first bearing within the first cavity of the primary housing; inserting the second bearing within the second cavity of the primary housing; coupling the worm gear to the first bearing and the second bearing; and coupling the hollow shaft within the third housing of the housing.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

A better understanding of the features and advantages of the present disclosure will be obtained by reference to the following detailed description that sets forth illustrative embodiments, in which the principles of the disclosed technology are utilized, and the accompanying drawings of which:

FIG. 1A illustrates an embodiment of a satellite antenna positioner system including a first slew drive and a second slew drive, according to some embodiments herein.

FIG. 1B illustrates the satellite antenna positioner system of FIG. 1A with the first slew drive and the second slew drive aligned in a vertical plane according to some embodiments herein.

FIG. 2A illustrates a satellite antenna positioner system with a partial exploded view of the slew drive assembly according to some embodiments herein.

FIGS. 2B-2D illustrate a slew drive assembly according to some embodiments herein.

FIG. 2E illustrates a slew drive including supporting arms for connecting to a second slew drive according to some embodiments herein.

FIG. 3 illustrates an assembled satellite antenna positioner system including a controller according to some embodiments herein.

FIG. 4A is a top-front-right perspective view illustration of an exemplary slew drive actuation system, per one or more embodiments herein.

FIG. 4B is a top-front-left perspective view illustration of an exemplary slew drive actuation system, per one or more embodiments herein.

FIG. 4C is front side view illustration of an exemplary slew drive actuation system, per one or more embodiments herein.

FIG. 4D is right side view illustration of an exemplary slew drive actuation system, per one or more embodiments herein.

FIG. 5A is front side cross-sectioned view illustration of an exemplary slew drive actuation system, per one or more embodiments herein.

FIG. 5B is front detailed side cross-sectioned view illustration of an exemplary slew drive actuation system, per one or more embodiments herein.

FIG. 5C is right side cross-sectioned view illustration of an exemplary slew drive actuation system, per one or more embodiments herein.

FIG. 5D is a first top-front-right cross-sectioned perspective view illustration of an exemplary slew drive actuation system, per one or more embodiments herein; and

FIG. 5E is a second top-front-right cross-sectioned perspective view illustration of an exemplary slew drive actuation system, per one or more embodiments herein.

FIGS. 6A-6B show two cutaway views of a slew drive including a first gear motor and a second gear motor according to some embodiments herein.

FIG. 7 shows a gearmotor according to some embodiments herein.

FIG. 8 shows a method for rotating an antenna according to some embodiments herein.

FIGS. 9A-9H show schematic diagrams of different views of a dual drive slew drive according to some embodiments herein.

FIGS. 10A-10D show schematic diagrams of different views of a cross-section of a single worm gear slew drive including a primary housing having one or more stops according to some embodiments herein.

### DETAILED DESCRIPTION

An objective of the disclosed technology is to provide a slew drive actuation system including a single worm gear configured to rotate a hollow shaft according to some embodiments herein. Another objective of the disclosed technology is to provide a slew drive actuation system including a dual drive slew drive having a pair of worm gears configured to rotate a hollow shaft in synchrony according to some embodiments herein.

Another objective of the disclosed technology is to provide a satellite antenna positioner system including a slew drive assembly having two dual drive slew drives configured to position an antenna in different orientations and maintain the position without requiring braking. Unlike systems which require brakes and high precision machined components, the slew drive assembly disclosed herein reduces precision tolerance requirements by utilizing differential biasing to remove mechanical mismatches and dual self-locking worms to eliminate the need for brakes, while still providing highly accurate and reliable positioning and orienting of payloads. In an example, differential biasing may include at least one of velocity, positional, or torque biasing between gear worms and gear wheels of at least one slew drive of the slew drive assembly. In some embodiments, the positioner system reduces a number of components and simplifies the overall system.

In some cases, the slew drive systems disclosed herein are used in the actuation of satellite dishes or arrays and other telecommunications equipment. For example, slew drive systems described herein can improve accuracy, efficiency, and reliability of systems used for tracking objects and signals in space (e.g., as the Earth rotates) while, in many cases, simultaneously reducing cost of manufacture.

According to some implementations, the positioner system may include a slew drive assembly including a first dual drive slew drive or first slew drive operatively coupled to a second dual drive slew drive or second slew drive. In some embodiments, the first slew drive and the second slew drive may be assembled vertically to reduce bending moments created by the moving antenna on the slew drives. In some embodiments, the satellite antenna positioner may rotate the antenna in multiple different directions by coordinating the rotations of the first slew drive and second slew drive, forming a dual drive slew drive assembly.

In some embodiments, each dual drive slew drive of the slew drive assembly is configured to mitigate against backlash which contributes to positioning errors. In addition, each dual drive of the slew drive assembly is configured to provide a self-locking mechanism which increases safety and eliminate need for brakes. Such drivetrain maximizes low-speed accuracy and positioning and may be further capable of higher speed bursts for rapidly retracing to rapidly locate another satellite target.

According to one aspect, each slew drive may include a threaded shaft having a threaded section or worm gear and a geared wheel having teeth or worm wheel. Each slew drive may be driven by a first gearmotor and second gearmotor, each gearmotor comprising a motor and a reducer assembly.

The system may include a first bracket connecting the first slew drive to the second dual-drive slew drive and a second bracket connecting the first slew drive to the satellite antenna. The system may further comprise a first sensor coupled with the first slew drive and a second sensor coupled with the second slew drive which measure the angle of rotation of the worm wheel of the corresponding slew drives. The system may further comprise a controller which receives the rotational information from the first and second sensors and applies control signals to the gearmotors to accurately control the position of the satellite antenna. In an example, the sensor may be an encoder configured to detect a rotation or position. In an example. the sensor can be an inertial measurement unit. In some embodiments, the encoder may be located on the axis of rotation, concentric with the worm wheel on each axis X and Y drives.

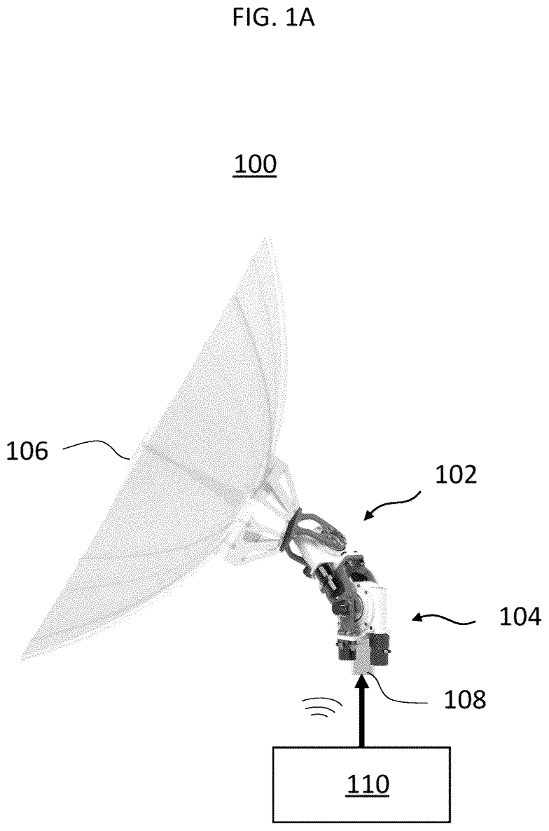

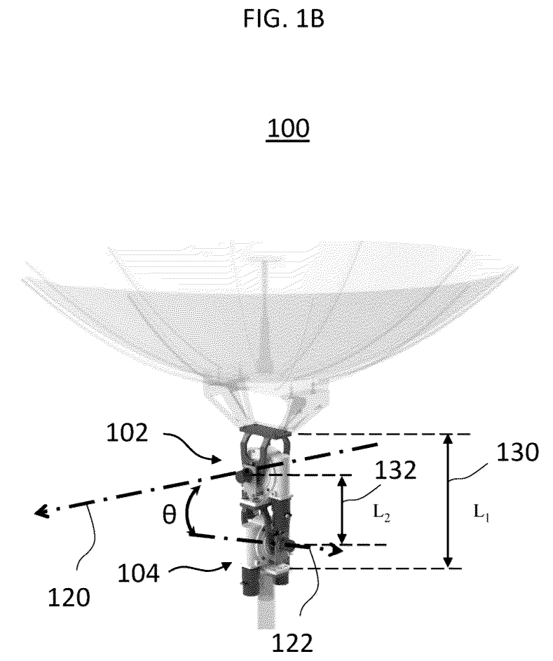

Turning to FIGS. 1A. 1B. 2A-2D and 3, an embodiment of a satellite antenna positioner system 100, 200, 300 is illustrated including a first slew drive 102 operatively coupled to a second slew drive 104 and a controller 110. As shown, the satellite antenna positioner system 100 may be configured to position a payload 106 in different orientations statically or dynamically. In some embodiments, the payload may be a telecommunications payload, a solar collection payload, an antenna, a crane arm, a lift, a positioner arm, a robotic arm, a medical imaging device, an adjustable bed, or any combination thereof. In an example, the satellite antenna positioner system may position an antenna spanning +/−5 degrees beyond each end of the horizon.

In some embodiments, the controller may be configured to send a control signal and/or power to move the slew drives in a coordinated fashion to accurately position the satellite antenna. In some embodiments, the controller may be configured to accurately position the package anywhere in the sky, tracking in low earth orbit (LEO), medium earth orbit (MEO), and/or geostationary orbit (GEO). In some embodiments, the slew drives may be actuated with fine tracking movement for high precision. In an example, the satellite antenna positioner system may discretely or continuously position the antenna at around 0.3-0.5 degrees per second. In an example, the slew drives may be actuated with gross tracking movement for repositioning around 16 degrees per second. According to some implementations, the controller may be configured to operate one or more motors at a continuous speed for tracking.

According to some implementations, the positioner system may include one or more sensors in communication with the controller 110 to accurately position the payload. In some embodiments, the positioner system may include one or more sensors 235 coupled with the payload and/or the second bracket connecting the first slew drive to the satellite antenna to directly sense a position and/or orientation. In some embodiments, the positioner system may include one or more sensors 236. 238, 336, 338 to monitor movement of each slew drive and calculate a position and/or orientation based on a prior calibration. In an example, each slew drive may include a sensor configured to measure an angle of rotation of the worm wheel of the corresponding slew drive and communicate it with the controller. In an example, the controller may be operatively coupled with the gearmotors of the corresponding slew drive, to accurately control the position of the satellite antenna. In an example, a sensor may be tuned to a motor current and/or rotation.

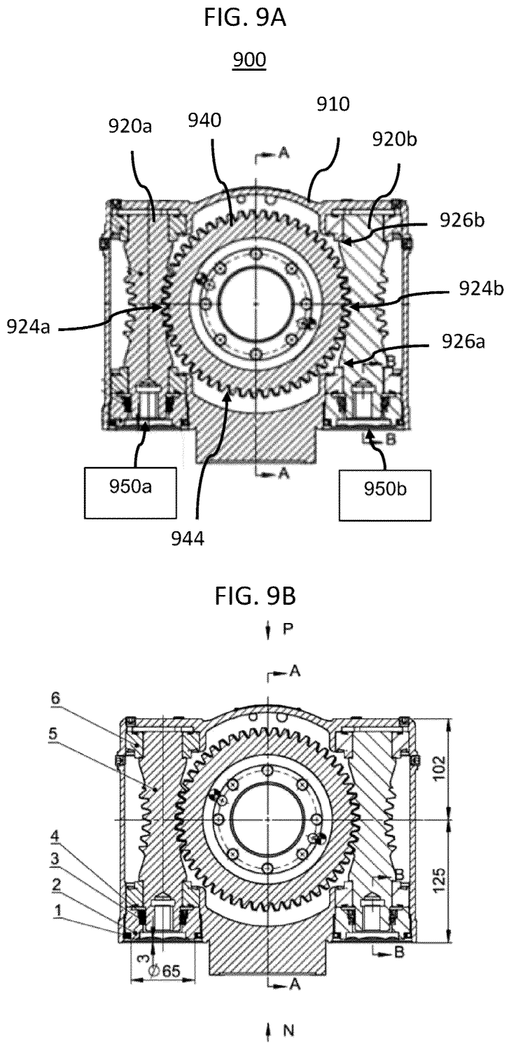

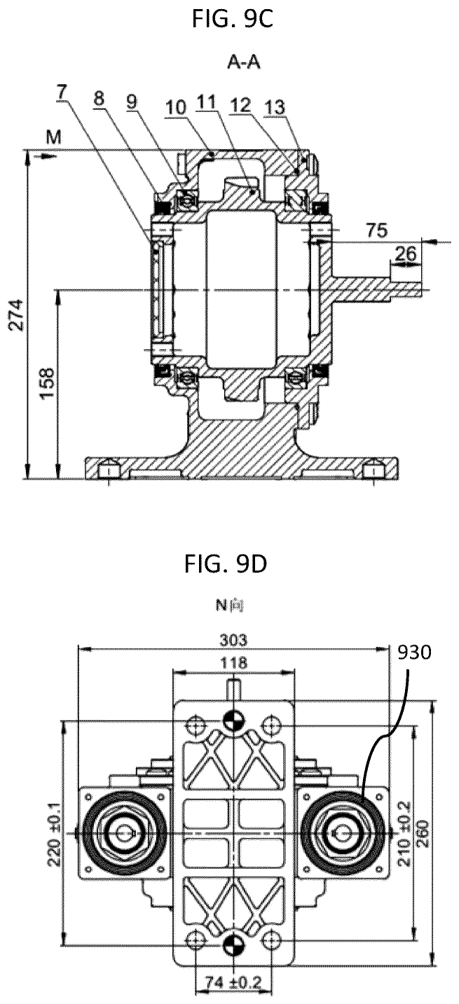

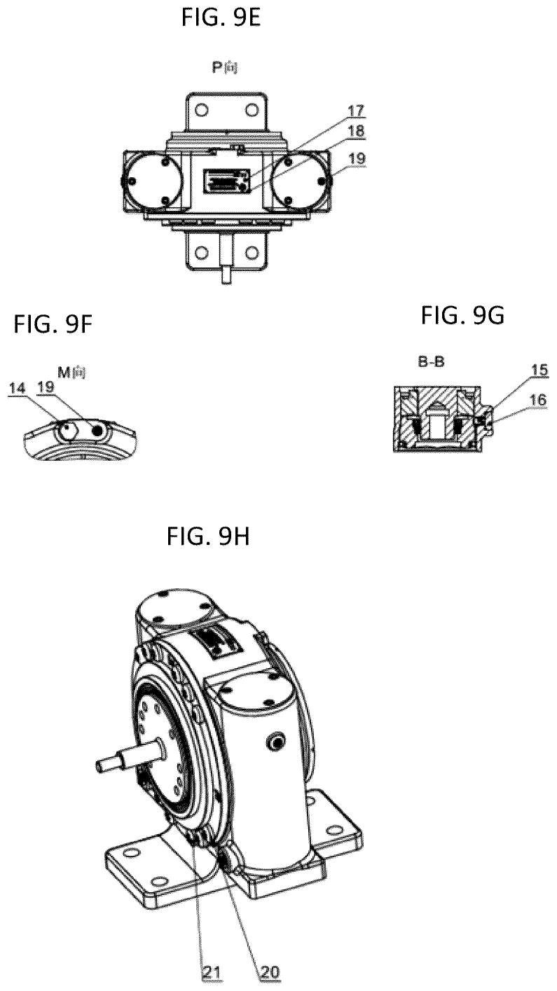

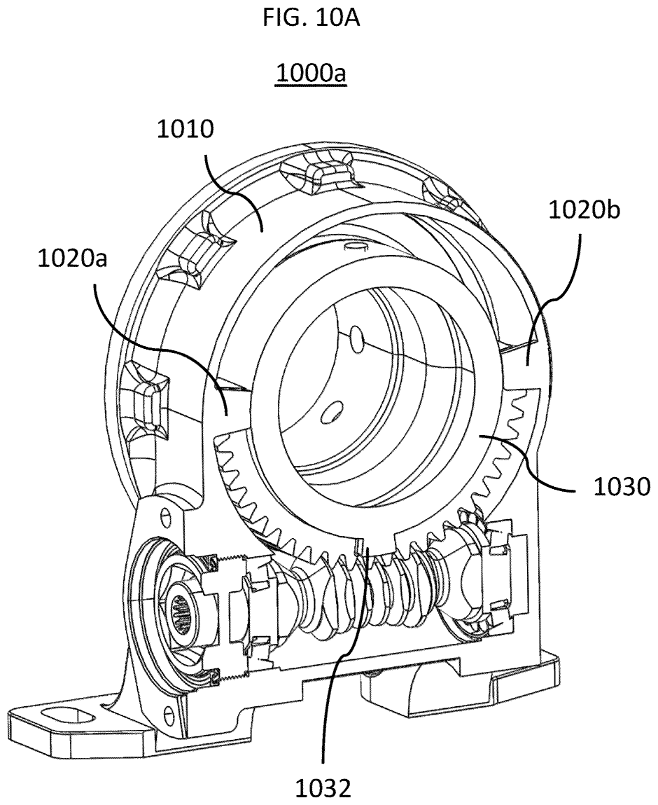

Turning to FIGS. 9A-9H. schematic diagrams are shown of different views of a dual drive slew drive 900 according to some embodiments herein. In some embodiments, a dual drive slew drive 900 may include a primary housing 910, a first worm gear 920a. a second worm gear 920b, a worm capture 930, and a hollow shaft 940. In some embodiments, rotating the worm gears 920a-b rotates the hollow shaft 940 in synchrony using a controller. In some embodiments, the worm gear 920 comprises a set of worm gear teeth 924 configured to engage or couple with a set of shaft gear teeth 944 of the hollow shaft 940. As shown in FIG. 9A, the worm gears 920a-b have 6 spiral gear teeth. Alternatively. the worm gear 920 may have 3, 4, 5, 7, 8, 9, 10, or more gear teeth. In an example. the first worm gear 620a, 920a may be driven by a first gearmotor 610a, 950a and the second worm gear 620b, 920b may be driven by a second gearmotor 610b, 950b.

In some embodiments, as shown, the worm gear 920 comprises a first shoulder 926a at a first end of the worm gear 920 and a second shoulder 926b at a second end of the worm gear 920 opposite the first end. The perpendicularity (or substantial perpendicularity) of the first shoulder 926a, the second shoulder 926b, or both, with respect to an axis of symmetry of the worm gear 920 ensures smooth consistent rotation of the worm gear 920 about the primary housing 910.

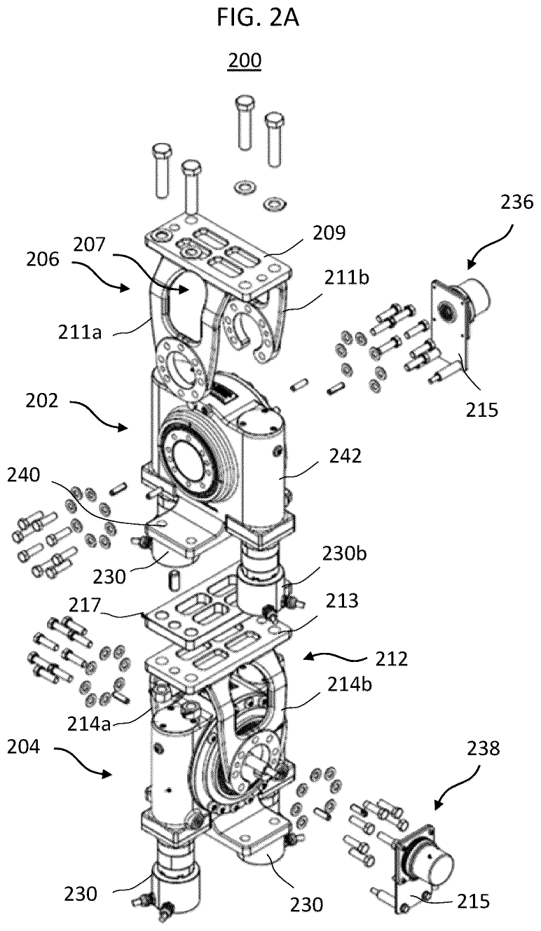

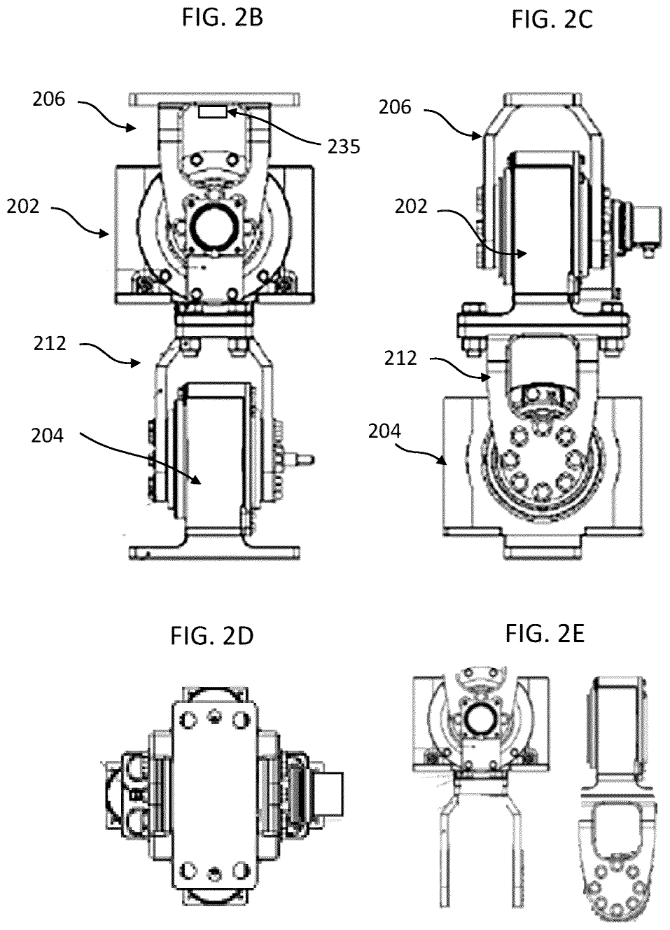

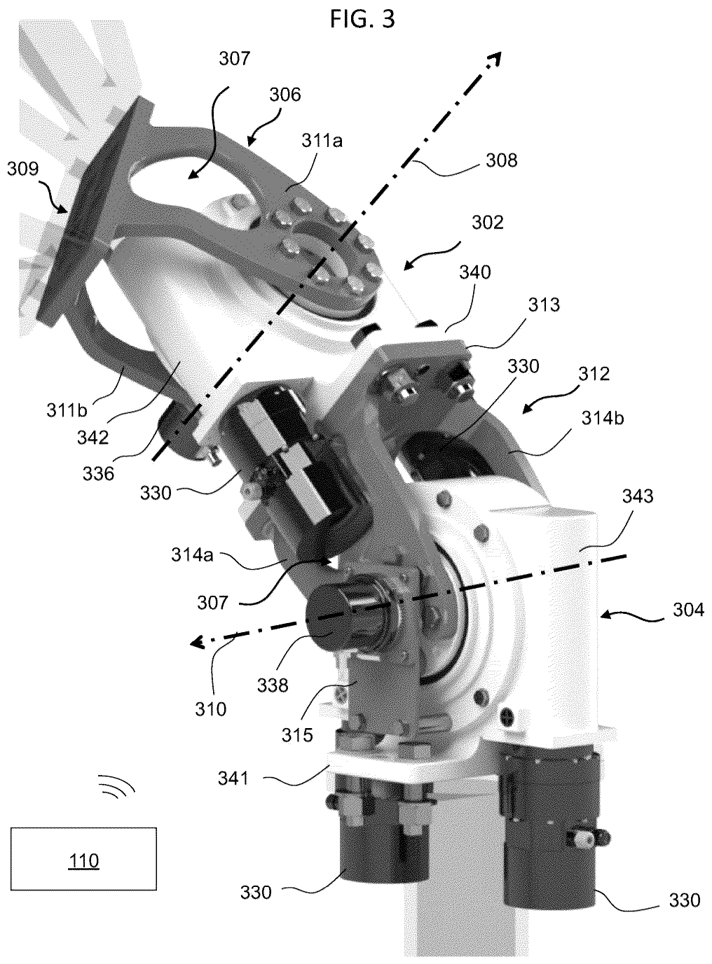

According to some implementations, the slew drive assembly may operatively couple a first slew drive to a second slew drive using one or more brackets. According to some implementations, the positioner system may connect the satellite antenna and a support structure or base 108 using one or more mounting brackets. Turning to FIGS. 2A-3, an embodiment of a satellite antenna positioner system 200, 300 is illustrated including a first slew drive 202, 302 operatively coupled to a second slew drive 204, 304. In an example, a first slew drive 202, 302 may include a housing 342 having a mounting pad 240, 340 and a second slew drive 304 may include a housing 243, 343 having a mounting pad 241, 341. In an example. the mounting pad 340 of the first slew drive may be configured to couple directly with a mounting pad 213, 313 of the second bracket 212, 312. The coupling may be secured using a number of bolts or other securing methods. According to some implementations, the first slew drive 202. 302 may be connected to an antenna using a first bracket 206, 306 having a mounting pad 209, 309 and supporting arms 211a-b, 311a-b. In some embodiments, the supporting arms 211a-b, 311a-b may include an indentation or aperture 207, 307 to provide clearance for a gearmotor, such as the gearmotors 230, 330. In an example, a second bracket 212, 312 may secure the first slew drive 202, 302 to the second slew drive 302, 304. The second bracket 212, 312 may have a mounting pad 213, 313 and supporting arms 214a-b, 314a-b including an indentation or aperture to provide clearance for a gearmotor. The second bracket 212, 312 may be secured to the mounting pad 240, 340 of the first slew drive 202, 302 and with a worm wheel of the second slew drive 204, 304. In an example, a third bracket 215, 315 may secure each sensor 236, 238 to a respective slew drive.

In some embodiments, the housing can be made in a variety of shapes. According to some implementations, the first slew drive 202, 302 and the second bracket 212, 312 may be fused together forming a unitary construction. In an example, a first slew drive may include a housing including supporting arms, such as supporting arms 214a-b, 314a-b, for connecting to the second slew drive 204, 304. (See FIG. 2E).

According to some implementations, the positioner system may include a mounting spacer 217. In an example, the mounting spacer 217 may be used to adjust L2. The spacers may be used to allow enough space for the motor 230 to not physically interfere with the drive 204 during operation. In some embodiments, the mounting spacer 217 may have a size based on the motor length. In an example, a motor and/or housing case may be sized to not require a spacer. In an example, a housing may include features of brackets 217, 214a, 214b. According to some implementations, the overall vertical length of the system may be further minimized by utilizing a single bracket to connect the first slew drive and the payload.

In an example, a first sensor 236, 336 may be coupled with the first slew drive 202, 302 whose shaft may be cast and machined onto the worm wheel. In some embodiments, the first sensor 236, 336 may be configured to provide maximum accuracy, eliminating stacking of error that would occur with separate parts. In an example, a second sensor 238, 338 may be coupled with the second slew drive 204, 304 whose shaft may be cast and machined onto the worm wheel. In an example, the gearmotors and the sensors may be positioned external to the assembly to provide ease of maintenance and replacement.

According to some implementations, each slew drive may be driven by a gearmotor comprising a motor and a reducer assembly. According to some implementations, each slew drive may include a first gearmotor and a second gearmotor located on a side of their respective worm wheel to accurately position the antenna. In an example, each gearmotor may comprise a motor and a reducer assembly. FIG. 7 shows a gearmotor 700, such as the gearmotors 230, 330. In some embodiments, an overall length of the gearmotor 700 may be minimized to provide for a compact satellite antenna positioning system. The gear motor may be a brushed DC or brushless DC or AC motor connected to a reducer gear assembly. In an example, the gear motor may have a planetary gear stack configured to achieve a reduction in rotations per minute (RPM) and increase in torque at the gear motor output. In an example, the worm gear may be configured to rotate along its own axis at a rotational speed causing the worm wheel to rotate along its axis at a different rotational speed. The axes of rotation of the worm gear and worm wheel are. in general. perpendicular or substantially perpendicular, although they can be at a different angle. According to some implementations, the system may include a gearmotor such as those described in Applicant's U.S. Pat. Nos. 9,816,600, 10,047,850, 10,655,766 and 10,955,040, each of which is incorporated herein by reference in its entirety.

A slew drive may include a threaded shaft having a threaded section or worm gear and a geared wheel having teeth or worm wheel. In some embodiments, the threaded section of the worm gear engages the teeth of the worm wheel thereby rotating the worm wheel. In some embodiments, the worm gear may be configured to rotate along its own axis at a rotational speed causing the worm wheel to rotate along its axis at a different rotational speed. The axes of rotation of the worm gear and worm wheel may be perpendicular, substantially perpendicular, or at a different angle.

As shown in FIG. 2A, the first slew drive 202 may have a first worm wheel having a first axis of rotation 120 through its center that is orthogonal to a second axis of rotation 122 through a center of a second worm wheel of the second slew drive 204. In some embodiments, the first and second slew drives may form a two-axis X-Y positioner. As shown, the worm wheels of the first slew drive 102 and the second slew drive 104 are rotated, illustrating repositioning of the antenna 106. The axis of rotation of the worm wheel of the first slew drive may be oriented 90 degrees from the axis of rotation of the worm wheel of the second slew drive. Accordingly, the rotated position may be maintained with no power required to maintain or braking.

According to some implementations, a vertical distance between the first and the second slew drives may be minimized to reduce bending moments created by the moving antenna on the slew drives. In an example, the system 200 may have an overall height L1 (130), as well as a height L2 (132) between the first and second slew drives 202 and 204. In some embodiments, the heights L1, L2 may be minimized to reduce the bending moments created by the moving antenna 206 on the slew drives 202 and 204. In some embodiments, the system can be sized to accommodate small to large payloads. In an example, smaller slew drives may be used for payloads up to 50 pounds while larger slew drives may be used for over a 1,000 pounds.

Turning to FIG. 3, an embodiment of a satellite antenna positioner system 300 is illustrated including a first slew drive 302 operatively coupled to a second slew drive 304. In some embodiments, the worm wheels of the first slew drive 302 are configured to rotate around a first axis of rotation 308. In an example, the worm wheel of the second slew drive 304 may be configured to rotate around a second axis of rotation 310. In some embodiments. the axis of rotation of their corresponding worm wheels are oriented at 90 degrees allowing the antenna to rotate in two orthogonal directions.

According to some implementations. a slew drive is a type of gearbox configured to withstand axial and radial loads while transmitting torque to drive an external unit. In some embodiments, the slew drive may be a dual drive slew drive 900 as shown in FIG. 9A. According to some implementations, the system may include a slew drive such as the slew drive of Applicant's U.S. Pat. Nos. 9,816,600, 10,047,850, 10,655,766 and 10,955,040.

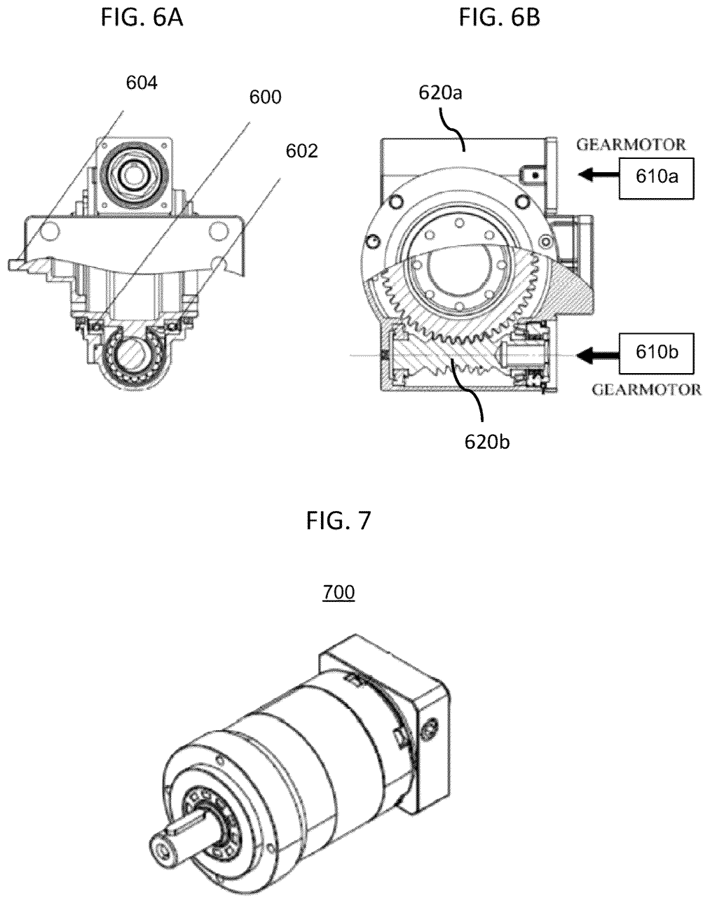

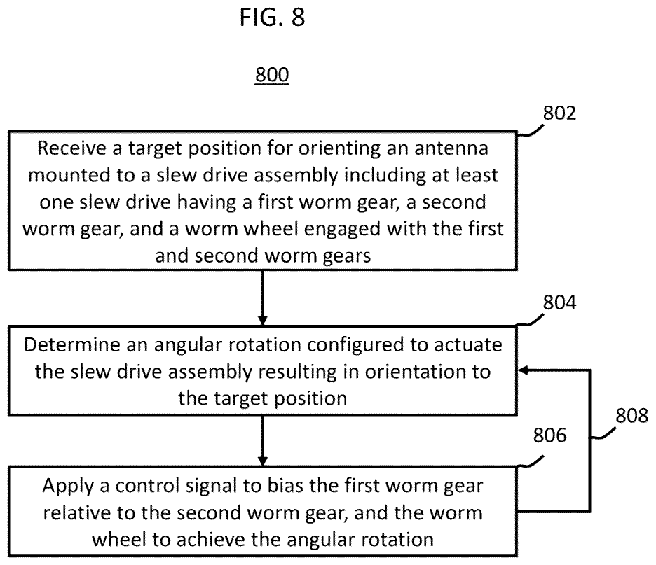

The system stiffness may be maximized by utilizing a housing that provides a bearing on each side of the worm wheel of the corresponding slew drive. The slew drive further includes bearings, seals, and other components which are secured within the housing. In some embodiments, the housing may include two ends where bearings may be positioned. In an example, the housing may include a tapered roller bearing on each end. In an example, the worm gear may be secured to the housing via the bearings. In an example, the worm gear may include one or more seals to maintain lubricants within the housing. In an example, each slew drive may utilize bearings 600, 602 to provide increased stiffness and accuracy (see FIGS. 6A-6B). In an example, the worm gear may include a sensor interface 604 to the worm wheel sensor.

In some embodiments, the housing may include one or more end caps configured to exert an axial compressive force on the worm gear which in turn exerts the axial force on the teeth of the work wheel. In some embodiments, each end cap may be secured to the housing using a number of bolts, typically 4 on each side. In some embodiments, the compressive force induced by the end cap ensures improved engagement between the threads of the worm gear and the teeth of the worm wheel.

According to some implementations, the controller may be coupled with the sensors of each slew drive and receive angular rotation information of their corresponding worm wheels. In an example, the controller may use the angular rotation information to controllably drive the gearmotors thereby accurately control the position of the satellite antenna. The controller may receive rotational information from each sensor by wired and/or wireless connection. Examples of rotational information include any indication of 3D position, rotational position, vector position vs time including a rate of rotation such as radians per second. In an example, the rotational information may be in a two-line element set (TLE) format.

In an example. the controller may receive rotational information from each sensor including position information. In an example, a specific vector may be provided to position using a transmitted voltage level like a servo motor.

In an example, based on the rotational information. the controller may be configured to apply control signals to the gearmotors 230, 330 of the first and second slew drives, 302 and 304. wired or wireless connection to accurately control the position of the payload. In an example, a controller can be a 68HC08 processor having internal flash memory available from Freescale of Austin, Texas. According to some implementations, the controller may include communication or power leads to the motor, a power supply, drivers, and a control board including a processor.

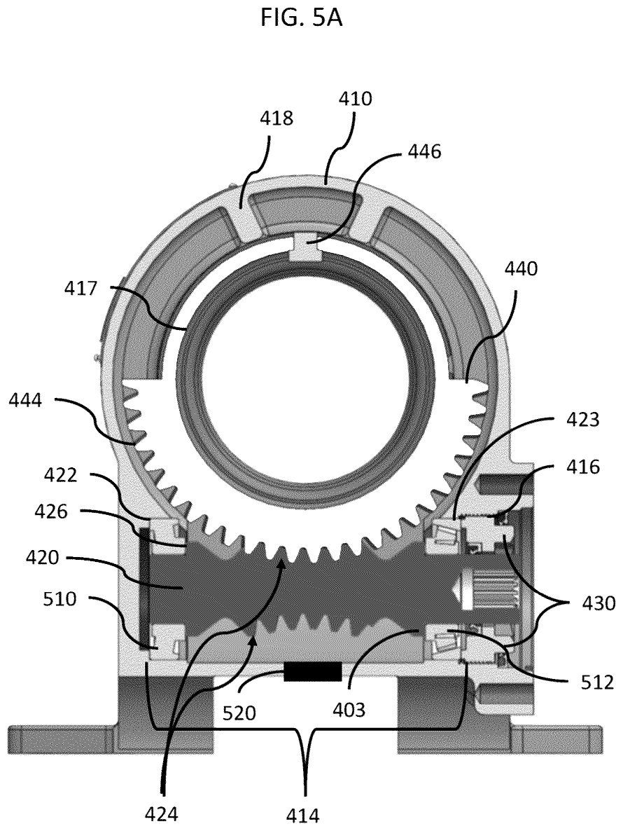

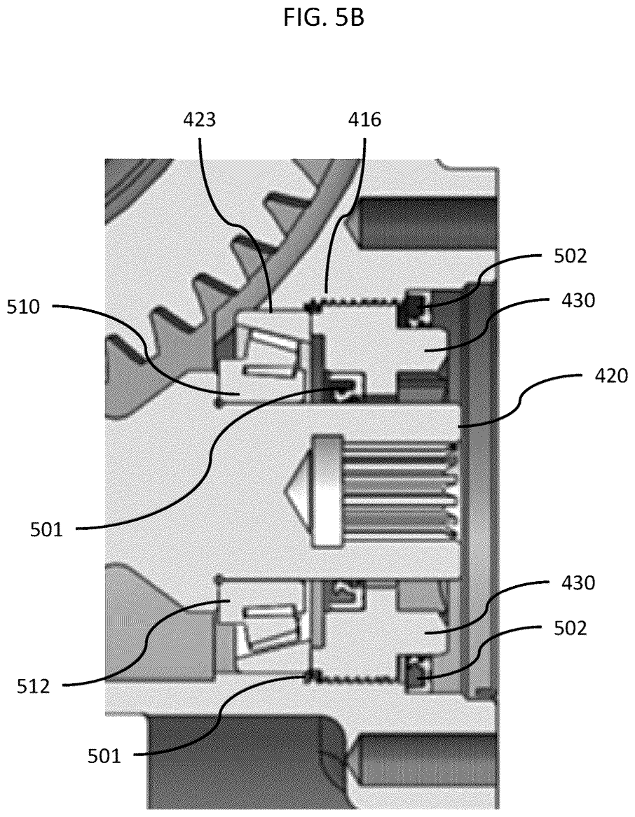

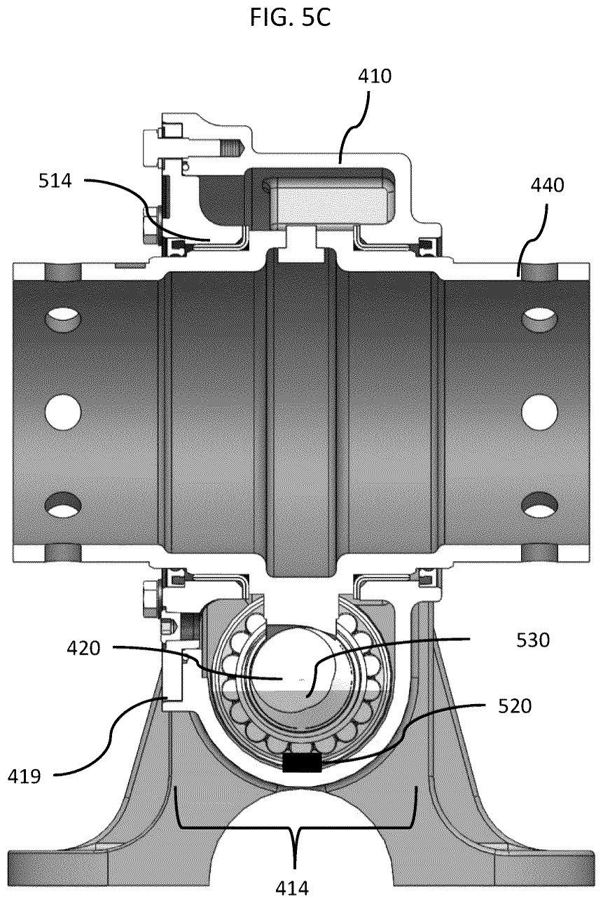

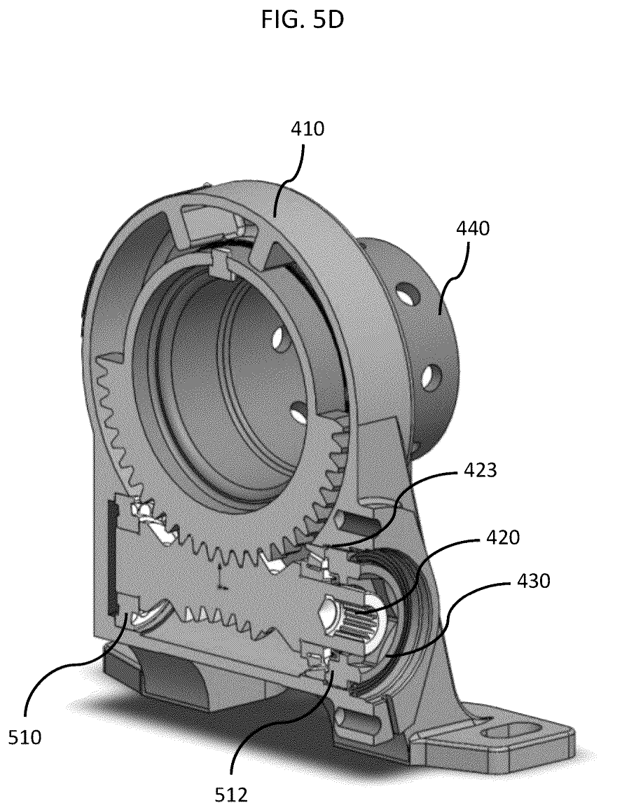

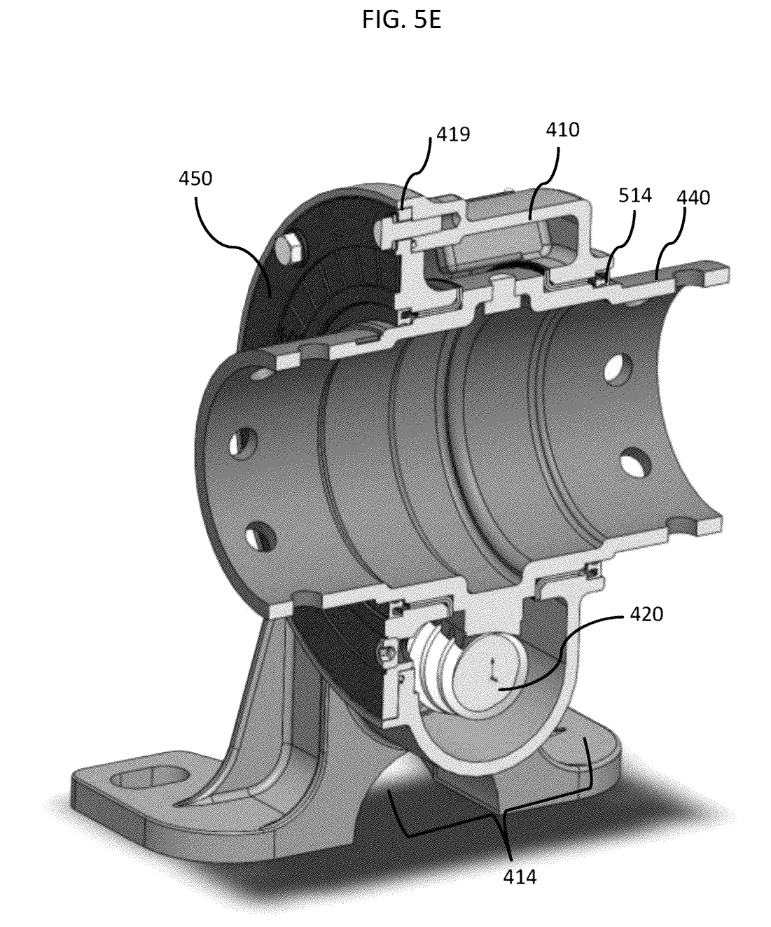

Provided herein, a slew drive actuation system 400 may include a primary housing 410, a first bearing 510, a second bearing 512, a worm gear 420, a worm capture 430, and a hollow shaft 440. In some embodiments, rotating the worm gear 420) rotates the hollow shaft 440. In some embodiments, the worm gear 420 comprises a set of worm gear teeth 424. As shown in FIG. 5A, the worm gear 420 has 6 spiral gear teeth. Alternatively, the worm gear 420 may have 3, 4, 5, 7, 8, 9, 10, or more gear teeth. In some embodiments, as shown, the worm gear 420 comprises a first shoulder 426 at a first end of the worm gear teeth 424 and a second shoulder 403 at a second end of the worm gear teeth 424 opposite the first end. The perpendicularity (or substantial perpendicularity) of the first shoulder 426, the second shoulder 403, or both, with respect to an axis of symmetry of the worm gear 420 ensures smooth consistent rotation of the worm gear 420 about the primary housing 410. In some embodiments, the hollow shaft 440 comprises shaft gear teeth 444 that couple with the worm gear teeth 424.

According to some implementations, the controller may controllably drive the gearmotors using a velocity biasing method. In an embodiment, a method 800 for rotating an antenna is provided including a step 802 of receiving a target position for orienting an antenna mounted to a slew drive assembly including at least one slew drive having a first worm gear, a second worm gear, and a worm wheel engaged with the first and second worm gears, a step 804 of determining an angular rotation configured to actuate the slew drive assembly resulting in orientation to the target, and a step 806 of applying a control signal to bias the first worm gear relative to the second worm gear, and the worm wheel to achieve the angular rotation. In some embodiments, the biasing of a worm gear includes controlling the motor of the gearmotor to turn the worm gear relative to another worm gear or the worm wheel. In some embodiments, the biasing is configured to maintain a position without braking and avoid backlash. In an example, the method 800 may further include a step 808 of repeating any of the previous steps for a second slew drive.

In an example, the biasing may include at least one of differential velocity, differential positions, or differential torque biasing between gear worms and gear wheels of at least one slew drive of the slew drive assembly. In an example, the control signal may bias the worm gears at a differential velocity or velocity bias with respect to a driving velocity or first velocity where at least some gears of each worm gear are in compression and/or torsion with the worm wheel. In an example, a first worm gear may include at least a portion of worm gear teeth 924a engaged with at least a portion of worm wheel teeth and a second worm gear may include at least a portion of worm gear teeth 924b engaged with at least a portion of worm wheel teeth. In an example, differential torque biasing may utilize a sensor such as a compression sensor configured to detect an amount of induced torque on the gears, the wheel, or the housing case.

In an example, a first worm gear may be instructed to move at a first velocity or first number of degrees per second and a second worm gear may be instructed to move at second number of degrees per second, which is greater than the first number of degrees per second. In some embodiments, the second worm gear is instructed to move at a faster rotational speed than the first worm gear. This “bias” in velocity may ensure the worm wheel of the slew drive is held in compression between the first and second worm gears, eliminating backlash from the gearing system and drastically increasing gear system pointing accuracy.

In an example, biasing the first worm gear relative to the second worm gear may include driving the first worm gear a first velocity and the second worm gear at a second velocity. In an example, the velocity of one worm gear may be about 5% greater or less than the velocity of the other worm gear. In some embodiments, the first worm gear and the second worm gear will have at least some teeth in compression and/or torsion with the worm wheel. In some embodiments, having at least one tooth of each worm gear in compression and/or torsion may be configured to reduce or avoid backlash and serve as a self-locking mechanism for the worm wheel.

Examples of velocities and velocity biases may include speeds resulting in a rotation of the assembly for tracking. In an example, tracking speeds can be around 0.3-0.5 degrees per second. In some embodiments, the velocity bias may be set at a speed according to a stress tolerance for compression or torsion of the gear of each slew drive.

Examples of receiving a target position include rotational information detected by the sensors. In some embodiments, the controller receives rotational information from the first and second sensors and applies a control signal to at least one of the gearmotors of at least one of the first worm gear of the first slew drive 302 and/or the second worm gear of the first slew drive 302.

According to some implementations, the control signal may be different or modified to each gearmotor such that a velocity bias may be generated between the first and second gearmotors of at least one slew drive. According to some implementations, the control signal may be identical to each gearmotor and at least one gearmotor may have a programed velocity bias in operating the corresponding motor in communication with a worm gear. According to some implementations, the control signal may control each gearmotor of each slew drive in a coordinated manner to maintain a smooth motion and avoid backlash.

The slew drive actuation system 400 herein may be configured to rotate a payload coupled to the hollow shaft 440. The payload may comprise, for example, a telecommunications payload, a solar collection payload, a crane arm, a lift, a positioner arm, a robotic arm, a medical imaging device, or an adjustable bed.

The payload may have a mass of about 1 kg to about 5,000 kg. The payload may have a mass of about 1 kg to about 10 kg, about 1 kg to about 25 kg, about 1 kg to about 50 kg, about 1 kg to about 100 kg, about 1 kg to about 250 kg, about 1 kg to about 500 kg, about 1 kg to about 1,000 kg, about 1 kg to about 2,500 kg, about 1 kg to about 5,000 kg, about 10 kg to about 25 kg, about 10 kg to about 50 kg, about 10 kg to about 100 kg, about 10 kg to about 250 kg, about 10 kg to about 500 kg, about 10 kg to about 1,000 kg, about 10 kg to about 2,500 kg, about 10 kg to about 5,000 kg, about 25 kg to about 50 kg, about 25 kg to about 100 kg, about 25 kg to about 250 kg, about 25 kg to about 500 kg, about 25 kg to about 1,000 kg, about 25 kg to about 2,500 kg, about 25 kg to about 5,000 kg, about 50 kg to about 100 kg, about 50 kg to about 250 kg, about 50 kg to about 500 kg, about 50 kg to about 1,000 kg, about 50 kg to about 2,500 kg, about 50 kg to about 5,000 kg, about 100 kg to about 250 kg, about 100 kg to about 500 kg, about 100 kg to about 1,000 kg, about 100 kg to about 2,500 kg, about 100 kg to about 5,000 kg, about 250 kg to about 500 kg, about 250 kg to about 1,000 kg, about 250 kg to about 2,500 kg, about 250 kg to about 5,000 kg, about 500 kg to about 1,000 kg, about 500 kg to about 2,500 kg, about 500 kg to about 5,000 kg, about 1,000 kg to about 2,500 kg, about 1,000 kg to about 5,000 kg, or about 2,500 kg to about 5,000 kg, including increments therein. The payload may have a mass of about 1 kg, about 10 kg, about 25 kg, about 50 kg, about 100 kg, about 250 kg, about 500 kg, about 1,000 kg, about 2,500 kg, or about 5,000 kg. The payload may have a mass of at least about 1 kg, about 10 kg, about 25 kg, about 50 kg, about 100 kg, about 250 kg, about 500 kg, about 1,000 kg, or about 2,500 kg. The payload may have a mass of at most about 10 kg, about 25 kg, about 50 kg, about 100 kg, about 250 kg, about 500 kg, about 1,000 kg, about 2,500 kg, or about 5,000 kg.

The payload may impart an axial load onto the hollow shaft 440 of about 1 N to about 1,000 N. The payload may impart an axial load onto the hollow shaft 440 of about 1 N to about 10 N, about 1 N to about 25 N, about 1 N to about 50 N, about 1 N to about 100 N, about 1 N to about 250 N, about 1 N to about 500 N, about 1 N to about 1,000 N, about 10 N to about 25 N, about 10 N to about 50 N, about 10 N to about 100 N, about 10 N to about 250 N, about 10 N to about 500 N, about 10 N to about 1,000 N, about 25 N to about 50 N, about 25 N to about 100 N, about 25 N to about 250 N, about 25 N to about 500 N, about 25 N to about 1,000 N, about 50 N to about 100 N, about 50 N to about 250 N, about 50 N to about 500 N, about 50 N to about 1,000 N, about 100 N to about 250 N, about 100 N to about 500 N, about 100 N to about 1,000 N, about 250 N to about 500 N. about 250 N to about 1,000 N, or about 500 N to about 1,000 N, including increments therein. The payload may impart an axial load onto the hollow shaft 440 of about 1 N, about 10 N, about 25 N, about 50 N, about 100 N, about 250 N, about 500 N, or about 1,000 N. The payload may impart an axial load onto the hollow shaft 440 of at least about 1 N, about 10 N, about 25 N, about 50 N, about 100 N, about 250 N, or about 500 N. The payload may impart an axial load onto the hollow shaft 440 of at most about 10 N, about 25 N, about 50 N, about 100 N, about 250 N, about 500 N, or about 1,000 N.

The payload may impart a torque onto the hollow shaft 440 of about 1 N-m to about 1,000 N-m. The payload may impart a torque onto the hollow shaft 440 of about 1 N-m to about 10 N-m, about 1 N-m to about 25 N-m, about 1 N-m to about 50 N-m, about 1 N-m to about 100N-m, about 1 N-m to about 250) N-m, about 1 N-m to about 500 N-m, about 1 N-m to about 1,000 N-m, about 10 N-m to about 25 N-m, about 10 N-m to about 50 N-m, about 10 N-m to about 100 N-m, about 10 N-m to about 250) N-m, about 10 N-m to about 500 N-m, about 10 N-m to about 1,000 N-m, about 25 N-m to about 50 N-m, about 25 N-m to about 100 N-m, about 25 N-m to about 250 N-m, about 25 N-m to about 500 N-m, about 25 N-m to about 1,000 N-m. about 50 N-m to about 100 N-m, about 50 N-m to about 250 N-m, about 50 N-m to about 500 N-m, about 50 N-m to about 1,000 N-m, about 100 N-m to about 250 N-m, about 100 N-m to about 500 N-m, about 100 N-m to about 1,000 N-m, about 250 N-m to about 500 N-m, about 250 N-m to about 1,000 N-m, or about 500 N-m to about 1,000 N-m, including increments therein. The payload may impart a torque onto the hollow shaft 440 of about 1 N-m, about 10 N-m, about 25 N-m, about 50 N-m, about 100 N-m, about 250 N-m, about 500 N-m, or about 1,000 N-m. The payload may impart a torque onto the hollow shaft 440 of at least about 1 N-m, about 10 N-m. about 25 N-m, about 50 N-m, about 100 N-m, about 250 N-m, or about 500 N-m. The payload may impart a torque onto the hollow shaft 440 of at most about 10 N-m. about 25 N-m, about 50 N-m, about 100 N-m, about 250 N-m, about 500 N-m, or about 1,000 N-m.

One or more of the components of the systems 400 herein can be hardened, tempered, austempered, induction hardened, or any combination thereof. One or more of the components of the systems 400 herein can be flame hardened, surface, hardened, induction hardened, heat treated, or any combination thereof. One or more of the components of the systems 400 may be formed of steel, stainless steel, copper, bronze, aluminum, or any combination thereof. In some embodiments, per FIG. 5A, the system 400 further comprises a magnet 520 coupled to the primary housing 410 between a first cavity 422 and a second cavity 423. The magnet 520 collects metallic particulate formed as the worm gear 420 and the gear teeth of the hollow shaft 440 wear against each other. Collecting such metallic particles prevents them from causing further wear and damage to the worm gear 420, the gear teeth of the hollow shaft 440, the first bearing 510, the second bearing 512, or any combination thereof. In some embodiments, the systems 400 herein further comprises a sealant, a thread-lock, or any combination thereof between any two or more components.

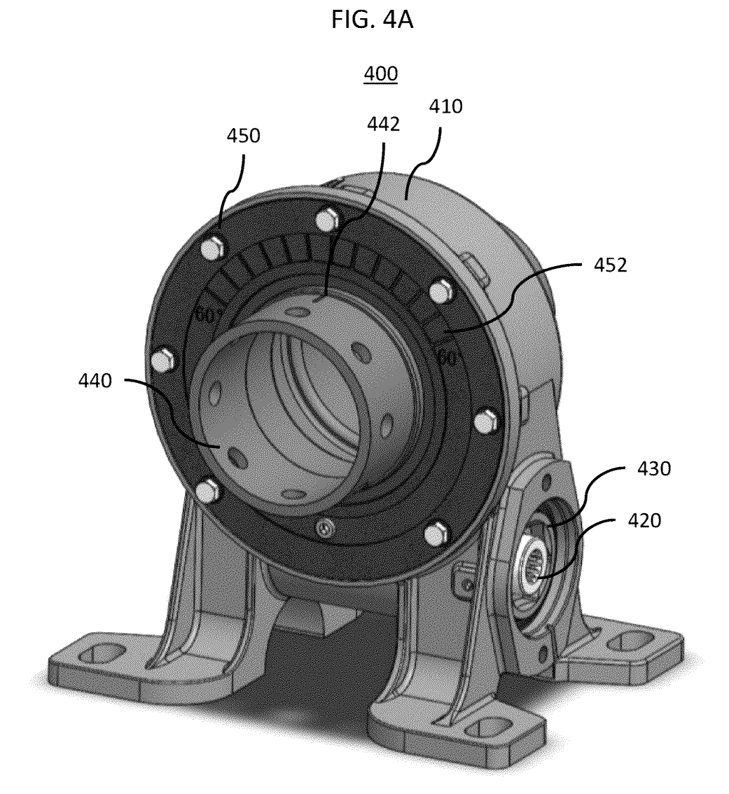

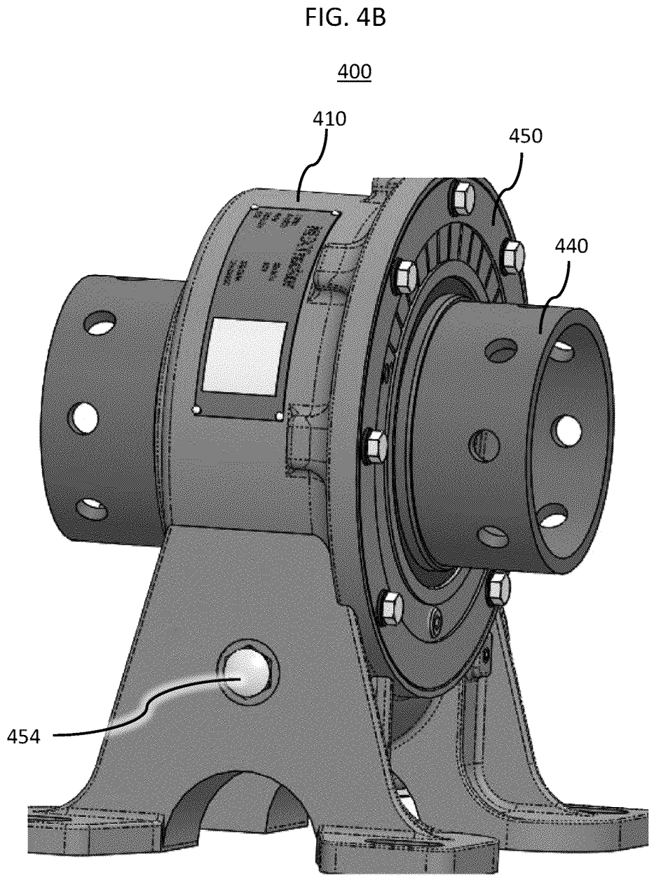

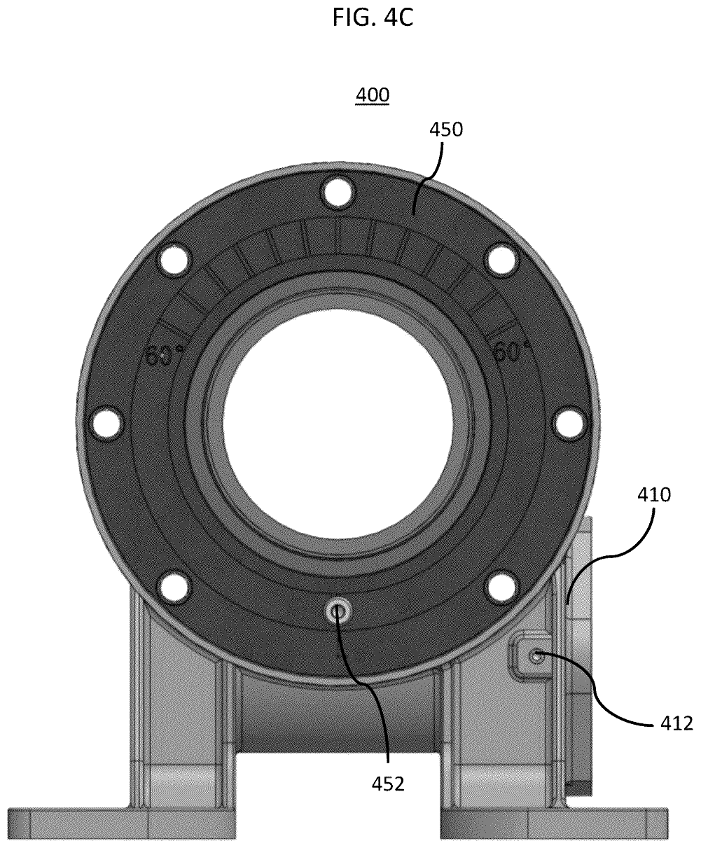

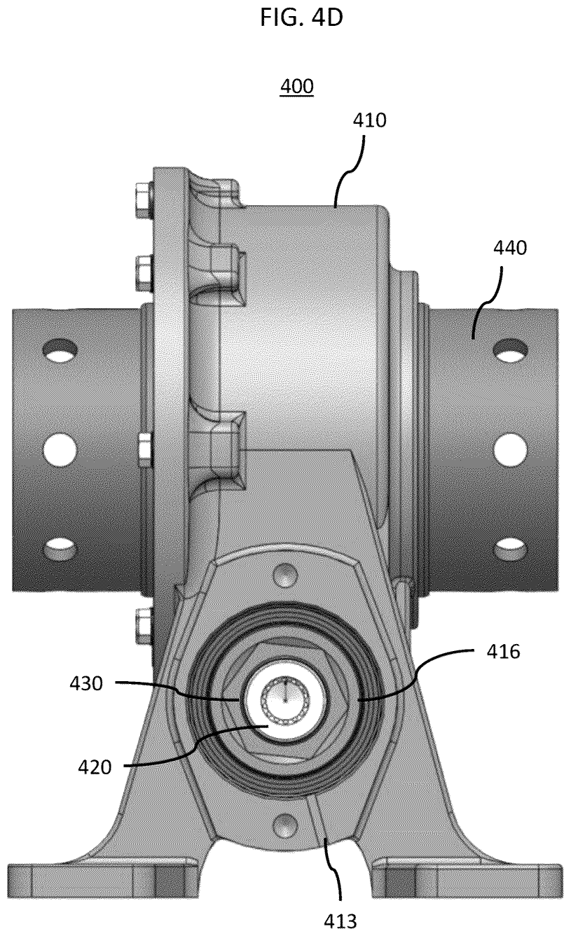

In some embodiments, the primary housing 410 comprises an oil bath portion 414, a threaded cavity 416, and a third cavity 417. In some embodiments, the system 400 further comprises an oil in the oil bath portion 414. In some embodiments, the oil comprises mineral oil, synthetic oil, vegetable oil, hydraulic oil, gear oil, compressor oil, turbine oil, or any combination thereof. In some embodiments, the oil has a viscosity of about 5,000 cP to about 15,000 cP. In some embodiments, the oil has a kinematic viscosity of about 2 cSt to about 25 cSt. The oil bath portion 414 may comprise a cavity that contains a volume of oil 530. The oil bath portion 414 may comprise a cavity that contains a volume of oil of about 8 oz, 10 oz, 12 oz, 14 oz, 16 oz, 18 oz, 20 oz, 24 oz, 28 oz, 32 oz, 36 oz, 40 oz, 50 oz, 60 oz, 70 oz, 80 oz, 90 oz, 100 oz, or more, including increments therein. The oil bath may contain a volume of oil such that at least a portion of the surface of the worm gear 420 may be in contact with the oil throughout operation. Oil may adhere to the surface of the worm gear 420 such that it may be transferred onto a surface of the gear teeth of the hollow shaft 440 as the worm gear 420 and the hollow shaft 440 rotate. Oil may draw any particulate formed by the wear between the worm gear 420 and the hollow shaft 440 to accumulate in a lower region of the oil bath to prevent such particulate from causing further wear. The surfaces of the oil bath may have a continuous depth (i.e., without holes or indents) to prevent oil and the particulates from accumulating therein. In some embodiments, per FIG. 4B, the primary housing 410 further comprises an oil leveling sight 454. As oil may leak out of the primary housing 410 through the bearings 510, 512, 514 or other outlets, the oil leveling sight 454 may allow a user to visually monitor a volume level and/or a color of the oil within the oil bath of the housing. The oil leveling sight 454 may be made of a transparent or a translucent material (e.g., glass or plastic). In some embodiments, the oil leveling sight 454 comprises a metal threading and a glass sight. The oil leveling sight 454 may have a marking that corresponds to a level or volume of oil in the oil bath portion 414. In some embodiments, per FIG. 4C, the secondary housing 450 comprises an oil fill plug 452. Alternatively, the primary housing 410 may comprise the oil fill plug 452. As oil may leak out of the primary housing 410 through the bearings 510, 512, 514 or other outlet, the oil fill plug 452 ensures that oil can be added to the primary housing 410 without requiring disassembly of the systems 400 herein. In some embodiments, the primary housing 410 further comprises a water drain slot 413. The water drain slot may be provided at the interface between the worm gear 420 and a motor/engine connected thereto to prevent sediment from accumulating therein and hindering connection and disconnection thereof.

In some embodiments, the oil bath portion 414 comprises a first cavity 422 and a second cavity 423. In some embodiments, the second cavity 423 may be concentric to the first cavity 102. In some embodiments, per FIG. 4D, the threaded cavity 416 may be concentric to the first cavity 102. The threaded cavity 416 may be threaded with straight threads or pipe threads. The system 400 may further comprise a thread lock applied to the threaded cavity 416. In some embodiments, the third cavity 417 may be perpendicular or substantially perpendicular to the first cavity 102.

In some embodiments, per FIGS. 5C and 5E, the primary housing 410 further comprises a fourth cavity 419 concentric to the third cavity 417, and where the system 400 further comprises a secondary housing 450 coupled to the primary housing 410 within the fourth cavity 419. The secondary housing 450 may allow access to the gear teeth of the hollow cylinder, the worm gear 420, an interior of the primary housing 410, or any combination thereof without requiring disassembly of the slew drive actuation systems 400 herein. As shown, the secondary housing 450 and the fourth cavity 419 can couple to each other by bolts. Alternatively, the secondary housing 450 and the fourth cavity 419 can couple to each other by a threaded feature, a clamp, a press fit, or any combination thereof. In some embodiments, the secondary housing 450 and the fourth cavity 419 removably couple to each other. In some embodiments, the secondary housing 450 and the fourth cavity 419 permanently couple to each other. In some embodiments, the secondary housing 450 and the fourth cavity 419 permanently couple to each other by a deformation fit, a crimp, or both. In some embodiments, the secondary housing 450 and the fourth cavity 419 couple to each other without fasteners. The system 400 may further comprise a seal between the primary housing 410 and the secondary housing 450. In some embodiments, as shown in FIG. 4A, the second housing 450 comprises a second housing indicator and the hollow shaft 440 comprise a hollow shaft indicator 442 indicating a rotational position of the hollow shaft 440 with respect to the primary housing 410, the secondary housing 450, or both. Alternatively, the primary housing 410 may comprise a primary housing indicator.

In some embodiments, per FIG. 5A, the primary housing 410 further comprises a stop 418 preventing the hollow shaft 440 from rotating about an angle greater than 360 degrees. The stop 418 may limit the rotation of the hollow shaft 440 by contacting a terminal face of the shaft gear teeth 444 of the hollow shaft 440. The stop 418 may prevent the hollow shaft 440 from rotating about an angle greater than 340 degrees, 320 degrees, 300 degrees, 280 degrees, 260degrees, 240 degrees, 220 degrees, 220 degrees, or less, including increments therein. As shown, the stop 418 may be a protrusion from an interior surface of the primary housing 410. Alternatively, the stop 418 may be adjustable within the primary housing 410.

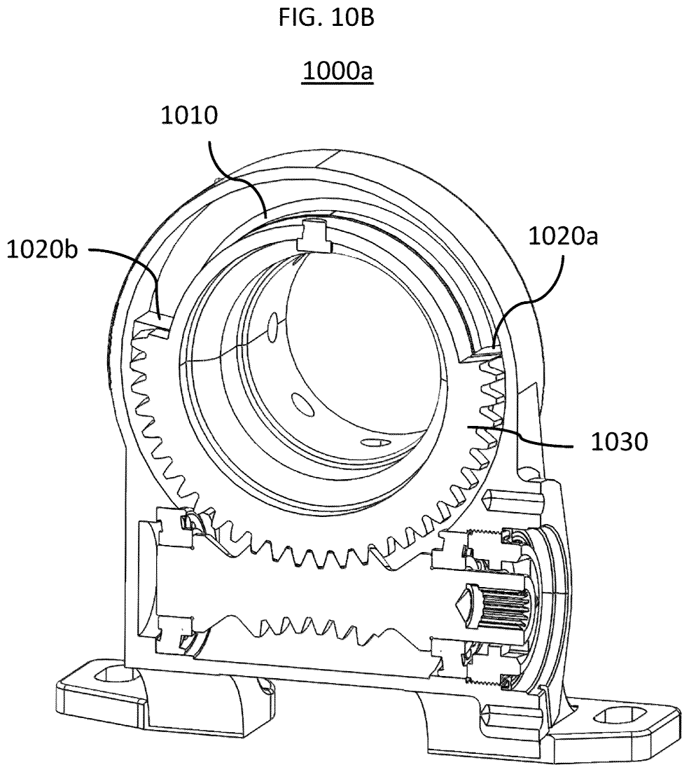

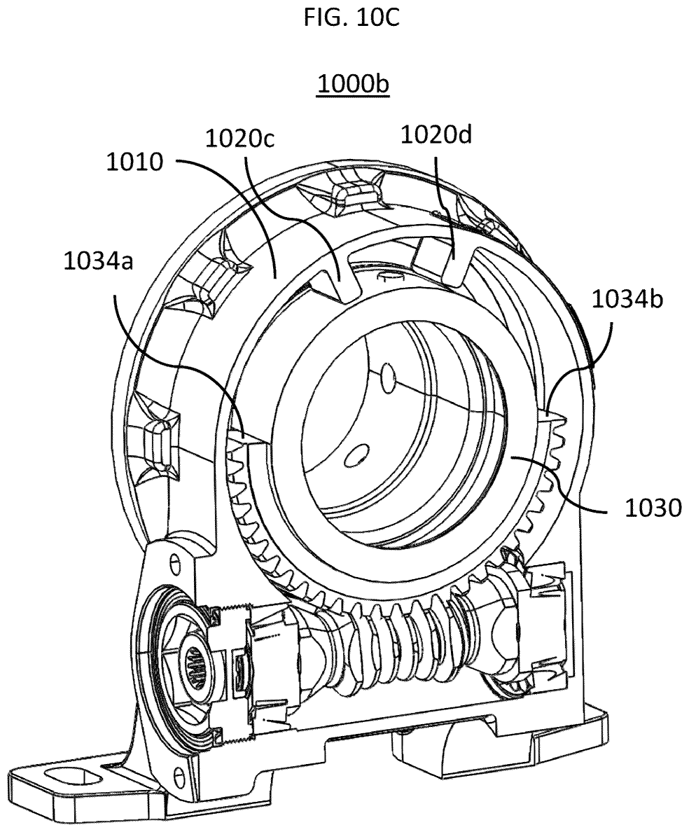

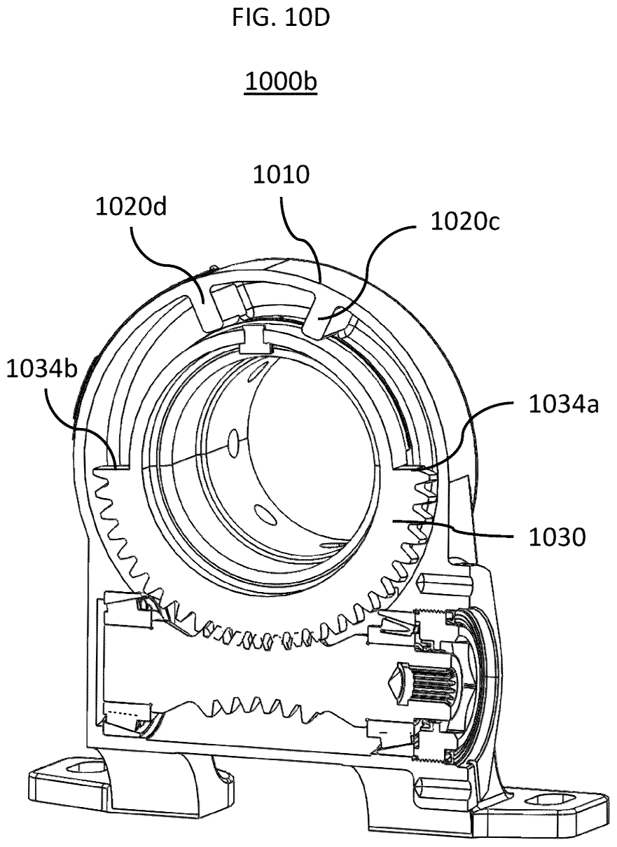

Turning to FIGS. 10A-10B, a single worm gear slew drive 1000a is shown including a primary housing 1010 having one or more housing stops 1020a-b and a worm wheel 1030 having a wheel stop 1032 according to some embodiments herein. In some embodiments, the one or more housing stops 1020a-b are configured to engage with the wheel stop 1032 to limit the range of motion in the worm wheel 1030. In some embodiments, the one or more housing stops 1020a-b may be placed at certain locations on the primary housing 1010 to allow for >+/−90 deg range of motion in the slew drive. In an example, the one or more housing stops 1020a-b may be positioned higher up radially on the primary housing 1010 to allow for greater range of motion.

Turning to FIGS. 10C-10D, a single worm gear slew drive 1000b is shown including a primary housing 1010 having one or more housing stops 1020c-d and a worm wheel 1030 having a first end 1034a and a second end 1034b configured to serve as a wheel stop according to some embodiments herein. In some embodiments. the one or more housing stops 1020c-d are configured to engage with either the first end 1034a and second end 1034b to limit the range of motion in the worm wheel 1030. In some embodiments, the one or more housing stops 1020c-d may be placed at certain locations on the primary housing 1010 to allow for >+/−90 deg range of motion in the slew drive. In an example, the one or more housing stops 1020c-d may be positioned lower radially on the primary housing 1010 to allow for less range of motion.

In some embodiments, the primary housing 410 further comprises a set screw 412, where actuating the set screw 412 prevents the rotation of the worm capture 430 about the primary housing 410. The set screw 412 may prevent rotation of the worm capture 430 about the primary housing 410 during inspection and/or repair. The set screw 412 may prevent the worm capture 430 from disconnecting from the housing 410.

In some embodiments, at least a portion of the surface of the primary housing 410 may be coated with an anti-corrosion primer. In some embodiments, the anti-corrosion primer comprises a zinc-rich primer, an epoxy primer, a polyurethane primer, a phosphate primer, a chromate primer, or any combination thereof. In some embodiments, at least a portion of the surface of the primary housing 410 may be unpainted or untreated to preserve sealing performance of the surface.

In some embodiments, the first bearing 510 may be coupled to the primary housing 410 within the first cavity 102. The first bearing 510 may be coupled to the primary housing 410 within the first cavity 422 by a clearance fit, a transition fit, or an interference fit. The first bearing 510 may be coupled to the primary housing 410 within the first cavity 422 by an adhesive, a set screw, a threaded feature, or any combination thereof. The first bearing 510 may be coupled to the primary housing 410 within the first cavity 422 by a force applied to the first bearing 510 by the worm capture 430. The first bearing 510 may be coupled to the primary housing 410 within the first cavity 422 without a fastener. The first bearing 510 may be removably coupled to the primary housing 410 within the first cavity 102. The first bearing 510 may be permanently coupled to the primary housing 410 within the first cavity 102. In some embodiments, the second bearing 512 may be coupled to the primary housing 410 within the second cavity 423. The second bearing 512 may be coupled to the primary housing 410 within the second cavity 423 by a clearance fit, a transition fit, or an interference fit. The second bearing 512 may be coupled to the primary housing 410 within the second cavity 423 by an adhesive, a set screw, a threaded feature, or any combination thereof. The second bearing 512 may be coupled to the primary housing 410 within the first cavity 422 by a force applied to the second bearing 512 by the worm capture 430. The second bearing 512 may be coupled to the primary housing 410 within the first cavity 422 without a fastener. The second bearing 512 may be removably coupled to the primary housing 410 within the first cavity 102. The second bearing 512 may be permanently coupled to the primary housing 410 within the first cavity 102.

In some embodiments, the system 400 further comprises a third bearing 514 coupled between the third cavity 417 of the primary housing 410 and the hollow shaft 440. The third bearing 514 may be coupled to the primary housing 410 within the third cavity 417 by a clearance fit, a transition fit, or an interference fit. The third bearing 514 may be coupled to the primary housing 410 within the third cavity 417 by an adhesive, a set screw, a threaded feature, or any combination thereof. The third bearing 514 may allow the hollow shaft 440 to rotate about the third cavity 417 of the primary housing 410 with increased stability and reduced friction.

In some embodiments, the first bearing 510, the second bearing 512, the third bearing 514, or any combination thereof, comprises a tapered roller bearing, a solid lubricant bearing, a dry lubricant bearing, or any combination thereof. The first bearing 510, the second bearing 512, the third bearing 514, or any combination thereof, may comprise an interface track that may be coated and/or formed of a low-friction material, such as polytetrafluoroethylene (PTFE). The specific types and orientations of the bearings 510, 512, 514 herein improve driveline efficiency and stability of the slew drives herein.

In some embodiments, the first bearing 510, the second bearing 512, the third bearing 514, or any combination thereof, has a raceway diameter of about 150 mm to about 750 mm. In some embodiments, the first bearing 510, the second bearing 512, the third bearing 514, or any combination thereof, has a raceway diameter of about 150 mm to about 200 mm, about 150 mm to about 250 mm, about 150 mm to about 300 mm, about 150 mm to about 350 mm, about 150mm to about 400 mm, about 150 mm to about 450 mm, about 150 mm to about 500 mm, about 150 mm to about 550 mm, about 150 mm to about 600 mm, about 150 mm to about 650 mm, about 150 mm to about 750 mm, about 200 mm to about 250 mm, about 200 mm to about 300 mm, about 200 mm to about 350 mm, about 200 mm to about 400 mm, about 200 mm to about 450 mm, about 200 mm to about 500 mm, about 200 mm to about 550 mm, about 200 mm to about 600 mm, about 200 mm to about 650 mm, about 200 mm to about 750 mm, about 250 mm to about 300 mm, about 250 mm to about 350 mm, about 250 mm to about 400 mm, about 250 mm to about 450 mm. about 250 mm to about 500 mm, about 250 mm to about 550 mm, about 250 mm to about 600 mm, about 250 mm to about 650 mm, about 250 mm to about 750 mm, about 300 mm to about 350 mm, about 300 mm to about 400 mm, about 300 mm to about 450 mm, about 300 mm to about 500 mm, about 300 mm to about 550 mm, about 300 mm to about 600 mm, about 300 mm to about 650 mm, about 300 mm to about 750 mm, about 350 mm to about 400 mm, about 350 mm to about 450 mm, about 350 mm to about 500 mm, about 350 mm to about 550 mm, about 350 mm to about 600 mm, about 350 mm to about 650 mm, about 350 mm to about 750 mm, about 400 mm to about 450 mm, about 400 mm to about 500 mm, about 400 mm to about 550 mm, about 400 mm to about 600 mm, about 400 mm to about 650 mm, about 400 mm to about 750 mm, about 450 mm to about 500 mm, about 450 mm to about 550 mm, about 450 mm to about 600 mm, about 450 mm to about 650 mm, about 450 mm to about 750 mm, about 500 mm to about 550 mm, about 500 mm to about 600 mm, about 500 mm to about 650 mm, about 500 mm to about 750 mm, about 550 mm to about 600 mm, about 550 mm to about 650 mm, about 550, mm to about 750 mm, about 600 mm to about 650 mm, about 600mm to about 750 mm, or about 650 mm to about 750 mm, including increments therein. In some embodiments, the first bearing 510, the second bearing 512, the third bearing 514, or any combination thereof, has a raceway diameter of about 150 mm, about 200 mm, about 250 mm, about 300 mm, about 350 mm, about 400 mm, about 450 mm, about 500 mm, about 550 mm, about 600 mm, about 650 mm, or about 750 mm. In some embodiments, the first bearing 510, the second bearing 512, the third bearing 514, or any combination thereof, has a raceway diameter of at least about 150 mm, about 200 mm, about 250 mm, about 300 mm, about 350 mm, about 4000 mm, about 450 mm, about 500 mm, about 550 mm, about 600 mm, or about 650 mm. In some embodiments, the first bearing 510, the second bearing 512, the third bearing 514, or any combination thereof, has a raceway diameter of at most about 200 mm, about 250 mm, about 300 mm, about 350 mm, about 400 mm, about 450 mm, about 500 mm, about 550 mm, about 600 mm, about 650 mm, or about 750 mm.

In some embodiments, the first bearing 510, the second bearing 512, the third bearing 514, or any combination thereof, provides an overturning moment of about 10 kN-m to about 500 kN-m. In some embodiments, the first bearing 510, the second bearing 512, the third bearing 514, or any combination thereof, provides an overturning moment of about 10 kN-m to about 50 kN-m, about 10 kN-m to about 100 kN-m, about 10 kN-m to about 150 kN-m, about 10 kN-m to about 200 kN-m, about 10 kN-m to about 250 kN-m, about 10 kN-m to about 300 kN-m, about 10 kN-m to about 350 kN-m, about 10 kN-m to about 400 kN-m, about 10 kN-m to about 450 kN-m, about 10 kN-m to about 500 kN-m, about 50 kN-m to about 100 kN-m, about 50 kN-m to about 150 kN-m, about 50 kN-m to about 200 kN-m, about 50 kN-m to about 250 kN-m, about 50 kN-m to about 300 kN-m, about 50 kN-m to about 350 kN-m, about 50 kN-m to about 400 kN-m, about 50 kN-m to about 450 kN-m, about 50 kN-m to about 500 kN-m, about 100 kN-m to about 150 kN-m, about 100 kN-m to about 200 kN-m, about 100 kN-m to about 250 kN-m, about 100 kN-m to about 300 kN-m, about 100 kN-m to about 350 kN-m, about 100 kN-m to about 400 kN-m, about 100 kN-m to about 450 kN-m, about 100 kN-m to about 500 kN-m, about 150 kN-m to about 200 kN-m, about 150 kN-m to about 250 kN-m, about 150 kN-m to about 300 kN-m, about 150 kN-m to about 350 kN-m, about 150 kN-m to about 400 kN-m, about 150 kN-m to about 450 kN-m, about 150 kN-m to about 500 kN-m, about 200 kN-m to about 250 kN-m, about 200 kN-m to about 300 kN-m, about 200 kN-m to about 350 kN-m, about 200 kN-m to about 400 kN-m, about 200 kN-m to about 450 kN-m, about 200 kN-m to about 500 kN-m, about 250 kN-m to about 300 kN-m, about 250 kN-m to about 350 kN-m, about 250 kN-m to about 400 kN-m, about 250 kN-m to about 450 kN-m, about 250 kN-m to about 500 kN-m, about 300 kN-m to about 350 kN-m, about 300 kN-m to about 400 kN-m, about 300 kN-m to about 450 kN-m, about 300 kN-m to about 500 kN-m, about 350 kN-m to about 400 kN-m, about 350 kN-m to about 450 kN-m, about 350 kN-m to about 500 kN-m, about 400 kN-m to about 450 kN-m, about 400 kN-m to about 500 kN-m, or about 450 kN-m to about 500 kN-m, including increments therein. In some embodiments, the first bearing 510, the second bearing 512, the third bearing 514, or any combination thereof, provides an overturning moment of about 10 kN-m, about 50 kN-m, about 100 kN-m, about 150 kN-m, about 200 kN-m, about 250 kN-m, about 300 kN-m, about 350 kN-m, about 400 kN-m, about 450 kN-m, or about 500 kN-m. In some embodiments, the first bearing 510, the second bearing 512, the third bearing 514, or any combination thereof, provides an overturning moment of at least about 10 kN-m, about 50 kN-m, about 100 kN-m, about 150 kN-m, about 200 kN-m, about 250 kN-m, about 300 kN-m, about 350 kN-m, about 400 kN-m, or about 450 kN-m. In some embodiments, the first bearing 510, the second bearing 512, the third bearing 514, or any combination thereof, provides an overturning moment of at most about 50 kN-m, about 100 kN-m, about 150 kN-m, about 200 kN-m, about 250 kN-m, about 300 kN-m, about 350 kN-m, about 400 kN-m, about 450 kN-m, or about 500 kN-m.

In some embodiments. the first bearing 510. the second bearing 512. the third bearing 514, or any combination thereof, has a survivability torque of about 5 kN-m to about 200 kN-m. In some embodiments, the first bearing 510, the second bearing 512, the third bearing 514, or any combination thereof, has a survivability torque of about 5 kN-m to about 10 kN-m, about 5 kN-m to about 25 kN-m, about 5 kN-m to about 50 kN-m, about 5 kN-m to about 75 kN-m, about 5 kN-m to about 100 kN-m, about 5 kN-m to about 125 kN-m, about 5 kN-m to about 150 kN-m, about 5 kN-m to about 175 kN-m, about 5 kN-m to about 200 kN-m, about 10 kN-m to about 25 kN-m, about 10 kN-m to about 50 kN-m, about 10 kN-m to about 75 kN-m, about 10 kN-m to about 100 kN-m. about 10) kN-m to about 125 kN-m. about 10 kN-m to about 150 kN-m, about 10 kN-m to about 175 kN-m, about 10 kN-m to about 200 kN-m, about 25 kN-m to about 50 kN-m, about 25 kN-m to about 75 kN-m, about 25 kN-m to about 100 kN-m, about 25 kN-m to about 125 kN-m, about 25 kN-m to about 150 kN-m, about 25 kN-m to about 175 kN-m, about 25 kN-m to about 200 kN-m, about 50 kN-m to about 75 kN-m, about 50 kN-m to about 100 kN-m, about 50 kN-m to about 125 kN-m, about 50 kN-m to about 150 kN-m, about 50 kN-m to about 175 kN-m, about 50 kN-m to about 200 kN-m, about 75 kN-m to about 100 kN-m, about 75 kN-m to about 125 kN-m, about 75 kN-m to about 150 kN-m, about 75 kN-m to about 175 kN-m, about 75 kN-m to about 200 kN-m, about 100 kN-m to about 125 kN-m, about 100 kN-m to about 150 kN-m, about 100 kN-m to about 175 kN-m, about 100 kN-m to about 200 kN-m, about 125 kN-m to about 150 kN-m, about 125 kN-m to about 175 kN-m, about 125kN-m to about 200 kN-m, about 150 kN-m to about 175 kN-m, about 150 kN-m to about 200kN-m, or about 175 kN-m to about 200 kN-m, including increments therein. In some embodiments, the first bearing 510, the second bearing 512, the third bearing 514, or any combination thereof, has a survivability torque of about 5 kN-m, about 10 kN-m, about 25 kN-m. about 50 kN-m, about 75 kN-m, about 100 kN-m, about 125 kN-m, about 150 kN-m, about 175 kN-m, or about 200 kN-m. In some embodiments, the first bearing 510, the second bearing 512, the third bearing 514, or any combination thereof, has a survivability torque of at least about 5 kN-m, about 10 kN-m, about 25 kN-m, about 50 kN-m, about 75 kN-m, about 100 kN-m, about 125 kN-m, about 150 kN-m, or about 175 kN-m. In some embodiments, the first bearing 510, the second bearing 512, the third bearing 514, or any combination thereof, has a survivability torque of at most about 10 kN-m, about 25 kN-m, about 50 kN-m, about 75 kN-m, about 100 kN-m. about 125 kN-m, about 150 kN-m, about 175 kN-m, or about 200 kN-m.

In some embodiments, the worm gear 420 may be coupled to the first bearing 510 and the second bearing 512. In some embodiments, at least a portion of the surface of the worm gear 420 may be in contact with oil within the oil bath during operation. Controlling the roughness of a surface of worm gear 420 may prevent and/or reduce lubricant leakage and wear. A low roughness of the worm gear teeth 424 ensures a sufficient lubrication boundary layer during operation to maintain a high drive efficiency and lifespan.

At least a portion of the surface of the worm gear 420 may have a roughness of about 0.1 μm to about 0.7 μm. At least a portion of the surface of the worm gear 420 may have a roughness of about 0.1 μm to about 0.2 μm, about 0.1 μm to about 0.3 μm, about 0.1 μm to about 0.4 μm, about 0.1 μm to about 0.5 μm, about 0.1 μm to about 0.6 μm, about 0.1 μm to about 0.7 μm, about 0.2 μm to about 0.3 μm, about 0.2 μm to about 0.4 μm, about 0.2 μm to about 0.5 μm, about 0.2 μm to about 0.6 μm, about 0.2 μm to about 0.7 μm, about 0.3 μm to about 0.4 μm, about 0.3 μm to about 0.5 μm, about 0.3 μm to about 0.6 μm, about 0.3 μm to about 0.7 μm, about 0.4 μm to about 0.5 μm, about 0.4 μm to about 0.6 μm, about 0.4 μm to about 0.7 μm, about 0.5 μm to about 0.6 μm, about 0.5 μm to about 0.7 μm, or about 0.6 μm to about 0.7 μm, including increments therein. At least a portion of the surface of the worm gear 420 may have a roughness of about 0.1 μm, about 0.2 μm, about 0.3 μm, about 0.4 μm, about 0.5 μm, about 0.6 μm, or about 0.7 μm. At least a portion of the surface of the worm gear 420 may have a roughness of at least about 0.1 μm, about 0.2 μm, about 0.3 μm, about 0.4 μm, about 0.5 μm, or about 0.6 μm. At least a portion of the surface of the worm gear 420 may have a roughness of at most about 0.2 μm. about 0.3 μm. about 0.4 μm. about 0.5 μm. about 0.6 μm, or about 0.7.

In some embodiments. the worm capture 430 may be coupled to the primary housing 410 within a threaded cavity 416. The slew drive actuation system 400 may further comprise an adhesive, a set screw, a threaded feature, or any combination thereof to secure the worm capture 430 within the primary housing 410. In some embodiments, as shown in FIG. 5A, the worm capture 430 abuts an outer surface of the second bearing 512. The worm capture 430 improves the sealing of the oil within the oil cavity of the primary housing 410. In some embodiments, the worm capture 430 has a machined HEX internal interface to couple to the threaded cavity 416 without additional tooling or parts.

In some embodiments. the worm capture 430 may be coupled to the primary housing 410 within a threaded cavity 416 with a set pre-load torque through the first bearing 510 and the second bearing 512. The set pre-load torque may be a torque required to turn the worm gear 420 with no load on the hollow shaft 440. The set pre-load torque may represent a friction within the first bearing 510 and the second bearing 512.

In some embodiments. the set pre-load torque may be about 2 Nm to about 20 Nm. In some embodiments. the set pre-load torque may be about 2 Nm to about 4 Nm, about 2 Nm to about 6 Nm, about 2 Nm to about 8 Nm, about 2 Nm to about 10 Nm, about 2 Nm to about 12 Nm, about 2 Nm to about 14 Nm, about 2 Nm to about 16 Nm, about 2 Nm to about 18 Nm, about 2 Nm to about 20 Nm, about 4 Nm to about 6 Nm, about 4 Nm to about 8 Nm, about 4 Nm to about 10 Nm, about 4 Nm to about 12 Nm, about 4 Nm to about 14 Nm, about 4 Nm to about 16 Nm, about 4 Nm to about 18 Nm, about 4 Nm to about 20 Nm, about 6 Nm to about 8 Nm, about 6 Nm to about 10 Nm, about 6 Nm to about 12 Nm, about 6 Nm to about 14 Nm, about 6 Nm to about 16 Nm, about 6 Nm to about 18 Nm, about 6 Nm to about 20 Nm, about 8 Nm to about 10 Nm, about 8 Nm to about 12 Nm, about 8 Nm to about 14 Nm, about 8 Nm to about 16 Nm, about 8 Nm to about 18 Nm, about 8 Nm to about 20 Nm, about 10 Nm to about 12 Nm, about 10 Nm to about 14 Nm, about 10 Nm to about 16 Nm, about 10 Nm to about 18 Nm, about 10 Nm to about 20 Nm, about 12 Nm to about 14 Nm, about 12 Nm to about 16 Nm, about 12 Nm to about 18 Nm, about 12 Nm to about 20 Nm, about 14 Nm to about 16 Nm, about 14 Nm to about 18 Nm, about 14 Nm to about 20 Nm, about 16 Nm to about 18 Nm, about 16 Nm to about 20 Nm, or about 18 Nm to about 20 Nm, including increments therein. In some embodiments, the set pre-load torque may be about 2 Nm, about 4 Nm, about 6 Nm, about 8 Nm, about 10 Nm, about 12 Nm, about 14 Nm, about 16 Nm, about 18 Nm, or about 20 Nm. In some embodiments, the set pre-load torque may be at least about 2 Nm, about 4 Nm, about 6 Nm, about 8 Nm, about 10 Nm, about 12 Nm, about 14 Nm, about 16 Nm, or about 18 Nm. In some embodiments, the set pre-load torque may be at most about 4 Nm, about 6 Nm, about 8 Nm. about 10 Nm, about 12 Nm, about 14 Nm, about 16 Nm, about 18 Nm, or about 20 Nm.

In some embodiments. per FIG. 5B. the worm capture 430 comprises an inner seal 501, an outer seal 502, or both, The inner seal 501, the outer seal 502, or both, may prevent the oil in the oil cavity from leaking out of the system 400 and may prevent dirt and particulate from entering the oil and the oil cavity to damage the worm gear 420, the gear teeth of the hollow shaft 440, or both. The inner seal 501, the outer seal 502, or both, may be formed of a plastic or a rubber, such as for example, nitrile rubber (nitrile butadiene rubber, NBR), hydrogenated nitrile butadiene rubber (HNBR), and/or polyvinyl chloride (PVC). The inner seal 501, the outer seal 502, or both, can comprise a backing for increased rigidity. The backing may be semi-rigid or flexible and may comprise a metal. The inner seal 501, the outer seal 502, or both, can be formed of natural rubber, synthetic rubber, silicone rubber, butyl rubber, neoprene rubber, EPDM rubber, nitrile rubber, viton rubber, polyurethane rubber, hypalon rubber, chlorosulfonated polyethylene rubber, fluoroelastomer rubber, ethylene-propylene rubber, styrene-butadiene rubber, acrylic rubber, or any combination thereof.

In some embodiments, the hollow shaft 440 may be coupled to the primary housing 410 within the third cavity 417. As shown in FIG. 5A, the hollow shaft 440 comprises 26 teeth. Alternatively, the hollow shaft 440 may comprise 10 teeth, 12 teeth, 14 teeth, 16 teeth, 18 teeth, 20 teeth, 22 teeth, 24 teeth, 28 teeth, 30 teeth, 32 teeth, 34 teeth, 36 teeth, 38 teeth, or 40 teeth, or more, including increments therein. Further as shown, the shaft gear teeth 444 extend about 180 degrees about an axis of rotation of the hollow shaft 440. Alternatively, the shaft gear teeth 444 extend about 100 degrees, 120 degrees, 140 degrees, 160 degrees, 200 degrees, 240 degrees, 260 degrees, 280 degrees, or more, including increments therein about an axis of rotation of the hollow shaft 440.

In some embodiments. the hollow shaft 440 further comprises a water-vapor breather 446 within an inner surface. The water-vapor breather 446 may enable any condensation within the primary housing 410 to escape. The water-vapor breather 446 may block oil from escaping the primary housing 410. The water-vapor breather 446 may couple to the hollow shaft 440 via a threaded feature, a seal, a press fit, a slip fit, an adhesive, or any combination thereof.

In some embodiments, a gear ratio between the worm gear 420 and the hollow shaft 440 may be about 2:1 to about 50:1. In some embodiments, a gear ratio between the worm gear 420 and the hollow shaft 440 may be about 50:1 to about 40:1. about 50:1 to about 30:1. about 50:1to about 20:1. about 50:1 to about 10:1. about 50:1 to about 8:1. about 50:1 to about 6:1. about 50:1 to about 4:1, about 50:1 to about 2:1, about 40:1 to about 30:1, about 40:1 to about 20:1, about 40:1 to about 10:1, about 40:1 to about 8:1, about 40:1 to about 6:1, about 40:1 to about 4:1, about 40:1 to about 2:1, about 30:1 to about 20:1, about 30:1 to about 10:1, about 30:1 to about 8:1, about 30:1 to about 6:1, about 30:1 to about 4:1, about 30:1 to about 2:1, about 20:1 to about 10:1, about 20:1 to about 8:1, about 20:1 to about 6:1, about 20:1 to about 4:1, about 20:1 to about 2:1, about 10:1 to about 8:1, about 10:1 to about 6:1, about 10:1 to about 4:1, about 10:1 to about 2:1, about 8:1 to about 6:1, about 8:1 to about 4:1, about 8:1 to about 2:1, about 6:1 to about 4:1, about 6:1 to about 2:1, or about 4:1 to about 2:1, including increments therein. In some embodiments, a gear ratio between the worm gear 420) and the hollow shaft 440 may be about 50:1, about 40:1, about 30:1, about 20:1, about 10:1, about 8:1, about 6:1, about 4:1, or about 2:1. In some embodiments, a gear ratio between the worm gear 420 and the hollow shaft 440 may be at least about 50:1, about 40:1, about 30:1, about 20:1, about 10:1, about 8:1, about 6:1, or about 4:1. In some embodiments, a gear ratio between the worm gear 420 and the hollow shaft 440 may be at most about 40:1, about 30:1, about 20:1, about 10:1, about 8:1, about 6:1,about 4:1. or about 2:1. In some embodiments, a gear ratio between the worm gear 420 and the hollow shaft 440 may be about 1:2 to about 1:50. In some embodiments, a gear ratio between the worm gear 420 and the hollow shaft 440 may be about 1:50 to about 1:40, about 1:50 to about 1:30, about 1:50 to about 1:20, about 1:50 to about 1:10, about 1:50 to about 1:8, about 1:50 to about 1:6, about 1:50 to about 1:4, about 1:50 to about 1:2, about 1:40 to about 1:30, about 1:40 to about 1:20, about 1:40 to about 1:10, about 1:40 to about 1:8, about 1:40 to about 1:6, about 1:40 to about 1:4, about 1:40 to about 1:2, about 1:30 to about 1:20, about 1:30 to about 1:10, about 1:30 to about 1:8, about 1:30 to about 1:6, about 1:30 to about 1:4, about 1:30 to about 1:2, about 1:20 to about 1:10, about 1:20 to about 1:8, about 1:20 to about 1:6, about 1:20 to about 1:4, about 1:20 to about 1:2, about 1:10 to about 1:8, about 1:10 to about 1:6, about 1:10 to about 1:4, about 1:10 to about 1:2, about 1:8 to about 1:6, about 1:8 to about 1:4, about 1:8 to about 1:2, about 1:6 to about 1:4, about 1:6 to about 1:2, or about 1:4 to about 1:2, including increments therein. In some embodiments, a gear ratio between the worm gear 420 and the hollow shaft 440 may be about 1:50, about 1:40, about 1:30, about 1:20, about 1:10, about 1:8, about 1:6, about 1:4, or about 1:2. In some embodiments, a gear ratio between the worm gear 420 and the hollow shaft 440 may be at least about 1:50, about 1:40, about 1:30, about 1:20. about 1:10, about 1:8, about 1:6, or about 1:4. In some embodiments, a gear ratio between the worm gear 420 and the hollow shaft 440 may be at most about 1:40, about 1:30, about 1:20, about 1:10, about 1:8, about 1:6, about 1:4, or about 1:2.

Controlling the roughness of a surface of hollow shaft 440 may prevent and/or reduce lubricant leakage and wear. A low roughness of the shaft gear teeth 444 ensures a sufficient lubrication boundary layer during operation to maintain a high drive efficiency and lifespan. At least a portion of the surface of the hollow shaft 440 may have a roughness of about 0.1 to about 0.7. At least a portion of the surface of the hollow shaft 440 may have a roughness of about 0.1 to about 0.2, about 0.1 to about 0.3, about 0.1 to about 0.4, about 0.1 to about 0.5, about 0.1 to about 0.6, about 0.1 to about 0.7, about 0.2 to about 0.3, about 0.2 to about 0.4, about 0.2 to about 0.5, about 0.2 to about 0.6, about 0.2 to about 0.7, about 0.3 to about 0.4, about 0.3 to about 0.5, about 0.3 to about 0.6, about 0.3 to about 0.7, about 0.4 to about 0.5, about 0.4 to about 0.6, about 0.4 to about 0.7. about 0.5 to about 0.6, about 0.5 to about 0.7, or about 0.6 to about 0.7, including increments therein. At least a portion of the surface of the hollow shaft 440 may have a roughness of about 0.1, about 0.2, about 0.3, about 0.4, about 0.5, about 0.6, or about 0.7. At least a portion of the surface of the hollow shaft 440 may have a roughness of at least about 0.1, about 0.2, about 0.3, about 0.4, about 0.5, or about 0.6. At least a portion of the surface of the hollow shaft 440 may have a roughness of at most about 0.2, about 0.3, about 0.4, about 0.5, about 0.6, or about 0.7.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated. As used herein, the term “about” in some cases refers to an amount that is approximately the stated amount. As used herein, the term “about” refers to an amount that is near the stated amount by 10%, 5%, or 1%, including increments therein. As used herein, the term “about” in reference to a percentage refers to an amount that is greater or less the stated percentage by 10%, 5%, or 1%, including increments therein. As used herein, the term “roughness” is an arithmetic average of the absolute values of the profile height deviations from the mean line. As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A positioning system for repositioning a payload, the system comprising:
at least one slew drive configured to rotatably secure to a payload, the at least one slew drive including a first worm gear, a second worm gear, and a worm wheel engaged with the first and second worm gears;
a first gearmotor configured to rotate the first worm gear;
a second gearmotor configured to rotate the second worm gear; and
a controller configured to bias at least one of the first gearmotor and the second gearmotor relative to the worm wheel.

2. The system of claim 1, wherein a modified control signal is configured to be sent to at least one slew drive such that a velocity bias is generated in at least one of the first gearmotor and the second gearmotor relative to the worm wheel.

3. The system of claim 1, wherein the at least one slew drive comprises a first slew drive and a second slew drive, wherein at least one of the first and second slew drives is configured to induce a velocity bias relative to the other slew drive of the first and second slew drives based on the control signal.

4. The system of any one of claim 1, wherein the biasing is based at least in part on positioning information.

5. The system of claim 1, wherein the payload is at least one of a telecommunications payload, a solar collection payload, an antenna, a crane arm, a lift, a positioner arm, a robotic arm, a medical imaging device, or an adjustable bed.

6. The system of claim 3, further comprising at least one sensor configured to measure positioning information of at least one of the antenna and the at least one slew drive.

7. The system of claim 6, wherein the at least one sensor includes at least one of an encoder and an inertial measurement unit.

8. The system of claim 6, wherein the at least one sensor is positioned on the payload and/or a bracket coupled to the payload to directly sense the positioning information.

9. The system of claim 6, wherein the at least one sensor is positioned on one or both of the first or second slew drive.

10. A positioning system for repositioning a payload, the system comprising:
a first slew drive including a first pair of worm gears and a first worm wheel;
a second slew drive including a second pair of worm gears and a second worm wheel;
at least one gearmotor configured to drive each worm gear of the first and second pair of worm gears; and
a controller in communication with each gearmotor, the controller configured to bias at least one of the first pair of worm gears and the second pair of worm gears relative to the worm wheel.

11. The system of claim 10, wherein the at least one gearmotor includes a motor and a reducer assembly configured to drive each slew drive.

12. The system of claim 10, further comprising a first bracket securing the first slew drive to the second slew drive and a second bracket securing the first slew drive to the payload.

13. The system of claim 10, wherein a modified control signal is sent to the at least one gearmotor such that a velocity bias is generated in the first and second gearmotor.

14. The system of claim 10, wherein at least one gearmotor includes a velocity bias based on the control signal.

15. The system of claim 10, wherein the payload includes at least one of a telecommunications payload, a solar collection payload, an antenna, a crane arm, a lift, a positioner arm, a robotic arm, a medical imaging device, or an adjustable bed.

16. The system of claim 10, wherein at least one of the of the first and second sensors includes at least one of an encoder and an inertial measurement unit.

17.-59. (canceled)

60. The system of claim 6, wherein the at least one sensor is configured to measure an angle of rotation of the worm wheel of the at least one slew drive.

61. The system of claim 60, wherein the controller is configured to receive rotational information based on the angle of rotation of the worm wheel from the one or more sensors and apply actuate the first gearmotor, the second gearmotor, or both to control the position of the at least one of the antenna.

62. The system of claim 61, wherein the rotation information comprises one or more of 3D position, rotational position, vector position versus time, or a rate of rotation in radians per second.

63. The system of claim 6, wherein the at least one sensor is tuned to a motor current, a rotation of the at least one slew drive, or both.
